(19) United States
(12) Patent Application Publication
(10) Pub. No.: US 2022/0239946 A1
(43) Pub. Date: Jul. 28, 2022

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG ELECTRONICS INC., Seoul (KR)

(72) Inventors: Yousun PARK, Seoul (KR); Sejin OH, Seoul (KR); Hyejung HUR, Seoul (KR)

(21) Appl. No.: 17/610,635

(22) PCT Filed: Feb. 26, 2020
(86) PCT No.: PCT/KR2020/002724

§ 371 Date: Nov. 11, 2021

Related U.S. Application Data
(60) Provisional application No. 62/857,243, filed on Jun. 4, 2019.

(51) Int. Cl. H04N 19/597; H04N 19/65; H04N 19/89; H04N 19/12; H04N 19/60

(52) U.S. Cl. CPC H04N 19/597; H04N 19/65; H04N 19/60; H04N 19/12; H04N 19/89

(57) ABSTRACT

A point cloud data transmission method according to embodiments may comprise the steps of: encoding point cloud data; and/or transmitting the encoded point cloud data. A point cloud data reception method according to embodiments may comprise the steps of: receiving point cloud data; decoding the point cloud data; and/or rendering the point cloud data.

### TECHNICAL FIELD

Embodiments provide a method for providing point cloud contents to provide a user with various services such as virtual reality (VR), augmented reality (AR), mixed reality (MR), and autonomous driving services.

### BACKGROUND ART

A point cloud is a set of points in a 3D space. It is difficult to generate point cloud data because the number of points in the 3D space is large.

A high throughput is required to transmit and receive data of the point cloud. In encoding/decoding point cloud data, the prediction method limits the area among the entire point cloud data, and then always applies predicted attribute information to the original attribute information within the corresponding range without a verification procedure.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Another object of the present disclosure is to improve the compression performance of the point cloud by improving the technology for encoding the attributes of geometry-point cloud compression (G-PCC).

Objects of the present disclosure are not limited to the aforementioned objects, and other objects of the present disclosure which are not mentioned above will become apparent to those having ordinary skill in the art upon examination of the following description.

### Technical Solution

To achieve these objects and other advantages and in accordance with embodiments, a method of transmitting point cloud data may include encoding point cloud data, and/or transmitting a bitstream containing the point cloud data and/or signaling information.

In some embodiments, the encoding of the point cloud data may include encoding geometry information based on position information about points of the point cloud data, reconstructing the geometry information, encoding attribute information about the points of the point cloud data based on the reconstructed geometry information, and/or error-compressing the encoded attribute information.

In some embodiments, the error-compressing may include reconstructing the encoded attribute information, determining whether to compress an attribute reconstruction error based on the reconstructed attribute information, the attribute reconstruction error indicating a residual between the reconstructed attribute information and the attribute information about the points of the point cloud data, generating the attribute reconstruction error based on a correspondence relationship between the reconstructed attribute information and the attribute information about the points of the point cloud data when the attribute reconstruction error is compressed, and/or compressing the attribute reconstruction error.

Further, in some embodiments, the method of transmitting point cloud may further include determining a performance unit of the attribute information for performing the compressing of the attribute reconstruction error. The compressing of the attribute reconstruction error may be compressing the attribute reconstruction error of the attribute information included in the performance unit of the attribute information, and the performance unit of the attribute information may be a tile. The signaling information may include information on the performance unit of the attribute information.

Further, in some embodiments, the signaling information may include information indicating whether to perform the error-compressing by reconstructing the transformed attribute information.

Further, in some embodiments, the correspondence relationship may be determined by at least one of direct coding, a method of constructing an error table using a nearest-neighbor search algorithm, and/or a method of constructing an error table using a least error point search algorithm based on a mean square error (MSE), wherein the signaling information may further include information related to whether a method of determining the correspondence relationship is carried out.

Also, the signaling information may further include information related to compressing the attribute reconstruction error.

In another aspect of the present disclosure, a method of receiving point cloud data may include receiving a bitstream containing point cloud data and signaling information, decoding the point cloud data, and/or rendering the point cloud data.

The decoding of the point cloud data may include reconstructing geometry information from a geometry bitstream of the bitstream, decoding an attribute bitstream of the bitstream, wherein the decoding comprises generating attribute information and residual information about points of the point cloud data, inversely transforming the attribute information about the points based on the reconstructed geometry information, and/or reconstructing the inversely transformed attribute information about the points based on the residual information.

Further, the signaling information may include first information indicating whether to reconstruct the attribute information, wherein the reconstructing of the inversely transformed attribute information about the points may include generating the reconstructed attribute information by adding or subtracting the residual information to or from the inversely transformed attribute information about the points according to the first information.

The signaling information may further include second information related to a correspondence relationship between the residual information and the inversely transformed attribute information about the points, and third information related to a compression method for the residual information. In addition, the reconstructing of the inversely transformed attribute information about the points may include adding or subtracting the residual information to or from the inversely transformed attribute information about the points based on the second information, and decoding the added or subtracted attribute information based on the third information.

### Advantageous Effects

A point cloud data transmission method, a point cloud transmission device, a point cloud data reception method, and a point cloud reception device according to embodiments may provide a good-quality point cloud service.

The point cloud data transmission method, the transmission device, the point cloud data reception method, and the reception device according to the embodiments may achieve various video codec schemes.

The point cloud data transmission method, the transmission device, the point cloud data reception method, and the reception device according to the embodiments may provide universal point cloud content such as a self-driving service.

According to embodiments, for values that cannot be output from the original point cloud data to the decoder, the error rate may be reduced with only small signaling. In addition, the attribute range may be variably clipped according to the characteristics of the data such that the attribute is present only in a specific range. Thereby, the attribute information may be efficiently decoded.

### DESCRIPTION OF DRAWINGS

The accompanying drawings illustrate embodiments of the disclosure and together with the description serve to explain the principle of the disclosure.

The drawings are included to provide a further understanding of the embodiments, and illustrate embodiments together with a description related to the embodiments. In the drawings:

FIG. 1 shows an exemplary point cloud content providing system according to embodiments;

FIG. 2 is a block diagram illustrating a point cloud content providing operation according to embodiments;

FIG. 3 illustrates an exemplary process of capturing a point cloud video according to embodiments;

FIG. 4 illustrates an exemplary point cloud encoder according to embodiments;

FIG. 5 shows an example of voxels according to embodiments;

FIG. 6 shows an example of an octree and occupancy code according to embodiments;

FIG. 7 shows an example of a neighbor node pattern according to embodiments;

FIG. 8 illustrates an example of point configuration in each LOD according to embodiments;

FIG. 9 illustrates an example of point configuration in each LOD according to embodiments;

FIG. 10 illustrates an exemplary point cloud decoder according to embodiments;

FIG. 11 illustrates an exemplary point cloud decoder according to embodiments;

FIG. 12 illustrates an exemplary transmission device according to embodiments;

FIG. 13 illustrates an exemplary reception device according to embodiments;

FIG. 14 illustrates an architecture for streaming G-PCC-based point cloud data according to embodiments;

FIG. 15 illustrates an exemplary point cloud transmission device according to embodiments;

FIG. 16 illustrates an exemplary point cloud reception device according to embodiments;

FIG. 17 illustrates an exemplary structure operatively connectable with a method/device for transmitting and receiving point cloud data according to embodiments;

FIG. 18 illustrates a point cloud encoder according to embodiments;

FIG. 19 illustrates an attribute reconstruction error compressor according to embodiments;

FIG. 20 illustrates a process of improving the image quality of a point cloud by an attribute reconstruction error compressor according to embodiments;

FIG. 21 illustrates a point cloud data encoder including an attribute reconstruction error compressor according to embodiments;

FIG. 22 shows results of rendering of a point cloud according to respective bitrates;

FIG. 23 shows original attribute information and attribute information reconstructed by an attribute reconstruction error compressor according to embodiments;

FIG. 24 illustrates a point cloud decoder according to embodiments;

FIG. 25 illustrates a residual information processor of a decoder of a point cloud data reception device according to embodiments;

FIG. 26 illustrates a decoder of a point cloud data reception device according to embodiments;

FIG. 27 shows an exemplary structure of point cloud data according to embodiments;

FIG. 28 shows a sequence parameter set (SPS) of a bitstream transmitted by a point cloud data transmission device (or a bitstream received by a point cloud data reception device) according to embodiments;

FIG. 29 shows a tile parameter set (TPS) of a bitstream transmitted by a point cloud data transmission device (or a bitstream received by a point cloud data reception device) according to embodiments;

FIG. 30 shows an attribute parameter set (APS) of a bitstream transmitted by a point cloud data transmission device (or a bitstream received by a point cloud data reception device) according to embodiments;

FIG. 31 shows an attribute slice header of Attr of a bitstream transmitted by a point cloud data transmission device (or a bitstream received by a point cloud data reception device) according to embodiments;

FIG. 32 is a flowchart illustrating a method of transmitting point cloud data according to embodiments;

FIG. 33 is a flowchart illustrating a method of receiving point cloud data according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

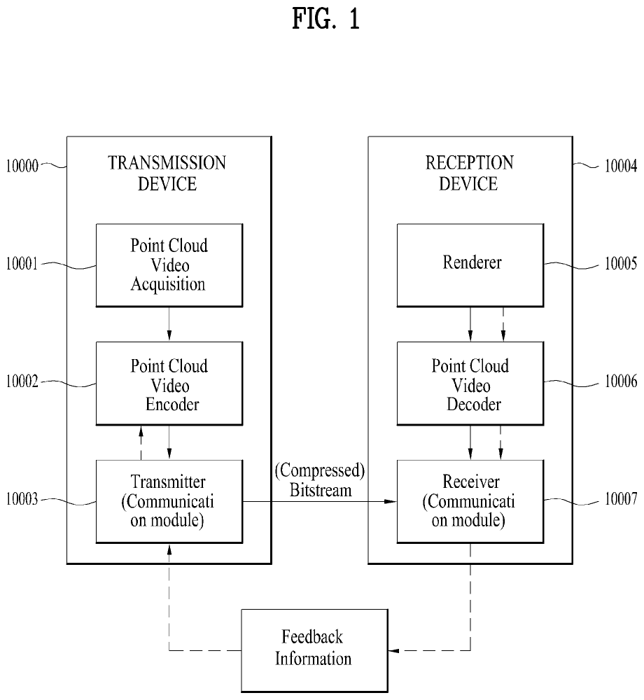

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquirer 10001, a point cloud video encoder 10002, and/or a transmitter (or communication module) 10003.

The point cloud video acquirer 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (for example, a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (for example, a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (for example, in a reverse process of the operation of the point cloud video encoder 10002). Accordingly, the point cloud video decoder 10006 may decode the point cloud video data by performing point cloud decompression coding, which is the inverse process of the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The point cloud content providing system may process (encode/decode) point cloud data based on the feedback information. Accordingly, the point cloud video data decoder 10006 may perform a decoding operation based on the feedback information. The reception device 10004 may transmit the feedback information to the transmission device 10000. The transmission device 10000 (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmission device, a transmitter, or the like, and the reception device 10004 may be called a decoder, a receiving device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

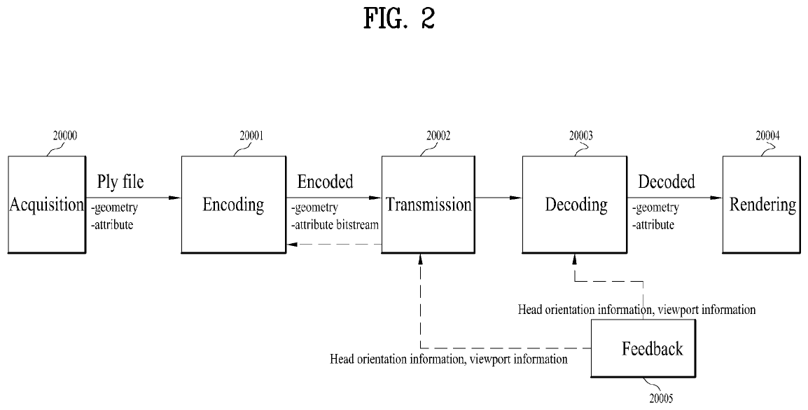

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (for example, the point cloud transmission device 10000 or the point cloud video acquirer 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (for example, values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, or the like, and the attribute may be called attributes, attribute information, attribute data, or the like. The point cloud content providing system (for example, the point cloud transmission device 10000 or the point cloud video acquirer 10001) may secure point cloud data from information (e.g., depth information, color information, etc.) related to the acquisition process of the point cloud video.

The point cloud content providing system (for example, the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (for example, the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (for example, signaling information related to the geometry encoding and the attribute encoding). The point cloud content providing system may encapsulate a bitstream that carries the encoded point cloud data and transmit the same in the form of a file or segment.

The point cloud content providing system (for example, the reception device 10004 or the receiver 10005) according to the embodiments may receive the bitstream containing the encoded point cloud data. In addition, the point cloud content providing system (for example, the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (for example, the reception device 10004 or the point cloud video decoder 10005) may decode the point cloud video data based on the signaling information related to encoding of the point cloud video data contained in the bitstream. The point cloud content providing system (for example, the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (for example, the reception device 10004 or the point cloud video decoder 10005) may reconstruct the point cloud video based on the positions according to the reconstructed geometry and the decoded attributes.

The point cloud content providing system according to the embodiments (for example, the reception device 10004 or the renderer 10007) may render the decoded point cloud data (20004). The point cloud content providing system (for example, the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (for example, the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

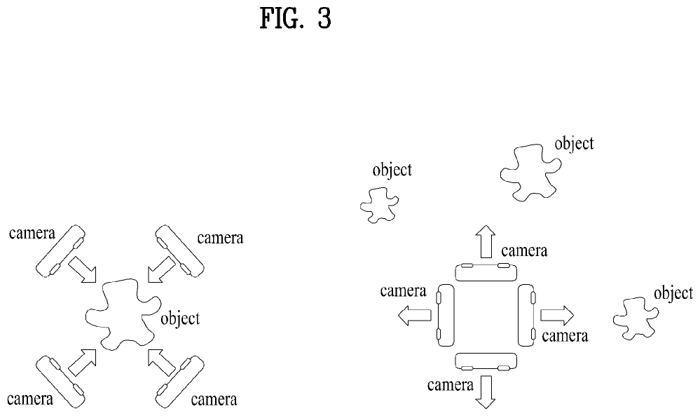

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in the figure, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (for example, a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

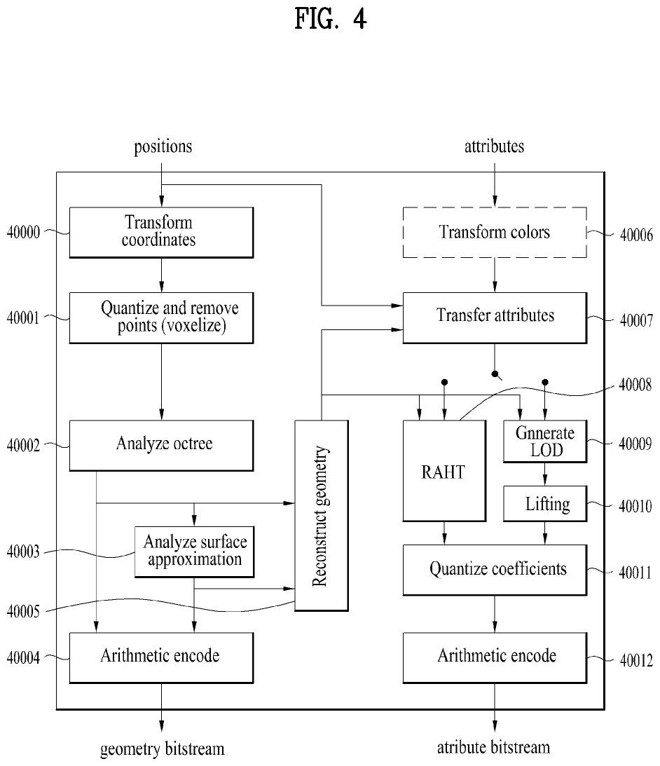

FIG. 4 illustrates an exemplary point cloud encoder according to embodiments.

FIG. 4 shows an example of the point cloud video encoder 10002 of FIG. 1. The point cloud encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud encoder may perform geometry encoding and attribute encoding. The geometry encoding is performed before the attribute encoding.

The point cloud encoder according to the embodiments includes a coordinate transformer (Transform coordinates) 40000, a quantizer (Quantize and remove points (voxelize)) 40001, an octree analyzer (Analyze octree) 40002, and a surface approximation analyzer (Analyze surface approximation) 40003, an arithmetic encoder (Arithmetic encode) 40004, a geometry reconstructor (Reconstruct geometry) 40005, a color transformer (Transform colors) 40006, an attribute transformer (Transform attributes) 40007, a RAHT transformer (RAHT) 40008, an LOD generator (Generate LOD) 40009, a lifting transformer (Lifting) 40010, a coefficient quantizer (Quantize coefficients) 40011, and/or an arithmetic encoder (Arithmetic encode) 40012.

The coordinate transformer 40000, the quantizer 40001, the octree analyzer 40002, the surface approximation analyzer 40003, the arithmetic encoder 40004, and the geometry reconstructor 40005 may perform geometry encoding. The geometry encoding according to the embodiments may include octree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 40000 according to the embodiments receives positions and transforms the same into coordinates. For example, the positions may be transformed into position information in a three-dimensional space (for example, a three-dimensional space represented by an XYZ coordinate system). The position information in the three-dimensional space according to the embodiments may be referred to as geometry information.

The quantizer 40001 according to the embodiments quantizes the geometry. For example, the quantizer 40001 may quantize the points based on a minimum position value of all points (for example, a minimum value on each of the X, Y, and Z axes). The quantizer 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 40001 according to the embodiments performs voxelization based on the quantized positions to reconstruct quantized points. As in the case of a pixel, which is the minimum unit containing 2D image/video information, points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 40001 may match groups of points in the 3D space with voxels. According to embodiments, one voxel may include only one point. According to embodiments, one voxel may include one or more points. In order to express one voxel as one point, the position of the center of a voxel may be set based on the positions of one or more points included in the voxel. In this case, attributes of all positions included in one voxel may be combined and assigned to the voxel.

The octree analyzer 40002 according to the embodiments performs octree geometry coding (or octree coding) to present voxels in an octree structure. The octree structure represents points matched with voxels, based on the octal tree structure.

The surface approximation analyzer 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformer 40006, the attribute transformer 40007, the RAHT transformer 40008, the LOD generator 40009, the lifting transformer 40010, the coefficient quantizer 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 40006 according to the embodiments performs color transform coding of transforming color values (or textures) included in the attributes. For example, the color transformer 40006 may transform the format of color information (for example, from RGB to YCbCr). The operation of the color transformer 40006 according to embodiments may be optionally applied according to the color values included in the attributes.

The geometry reconstructor 40005 according to the embodiments reconstructs (decompresses) the octree and/or the approximated octree. The geometry reconstructor 40005 reconstructs the octree/voxels based on the result of analyzing the distribution of points. The reconstructed octree/voxels may be referred to as reconstructed geometry (restored geometry).

The attribute transformer 40007 according to the embodiments performs attribute transformation to transform the attributes based on the reconstructed geometry and/or the positions on which geometry encoding is not performed. As described above, since the attributes are dependent on the geometry, the attribute transformer 40007 may transform the attributes based on the reconstructed geometry information. For example, based on the position value of a point included in a voxel, the attribute transformer 40007 may transform the attribute of the point at the position. As described above, when the position of the center of a voxel is set based on the positions of one or more points included in the voxel, the attribute transformer 40007 transforms the attributes of the one or more points. When the trisoup geometry encoding is performed, the attribute transformer 40007 may transform the attributes based on the trisoup geometry encoding.

The attribute transformer 40007 may perform the attribute transformation by calculating the average of attributes or attribute values of neighboring points (e.g., color or reflectance of each point) within a specific position/radius from the position (or position value) of the center of each voxel. The attribute transformer 40007 may apply a weight according to the distance from the center to each point in calculating the average. Accordingly, each voxel has a position and a calculated attribute (or attribute value).

The attribute transformer 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generator 40009 according to the embodiments generates a level of detail (LOD) to perform prediction transform coding. The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 40010 according to the embodiments performs lifting transform coding of transforming the attributes a point cloud based on weights. As described above, lifting transform coding may be optionally applied.

The coefficient quantizer 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud encoder of FIG. 4 may be implemented by hardware including one or more processors or integrated circuits configured to communicate with one or more memories included in the point cloud providing device, software, firmware, or a combination thereof. The one or more processors may perform at least one of the operations and/or functions of the elements of the point cloud encoder of FIG. 4 described above. Additionally, the one or more processors may operate or execute a set of software programs and/or instructions for performing the operations and/or functions of the elements of the point cloud encoder of FIG. 4. The one or more memories according to the embodiments may include a high speed random access memory, or include a non-volatile memory (e.g., one or more magnetic disk storage devices, flash memory devices, or other non-volatile solid-state memory devices).

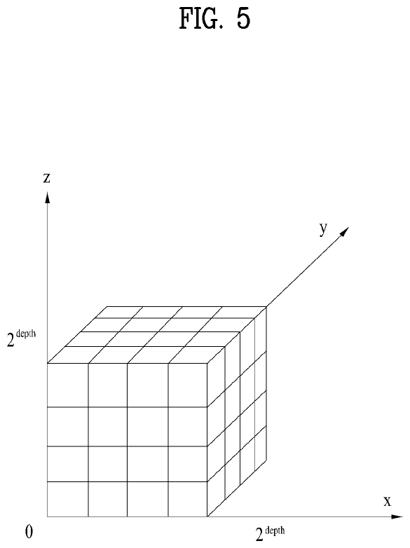

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud encoder (e.g., the quantizer 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2d, 2d, 2d) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

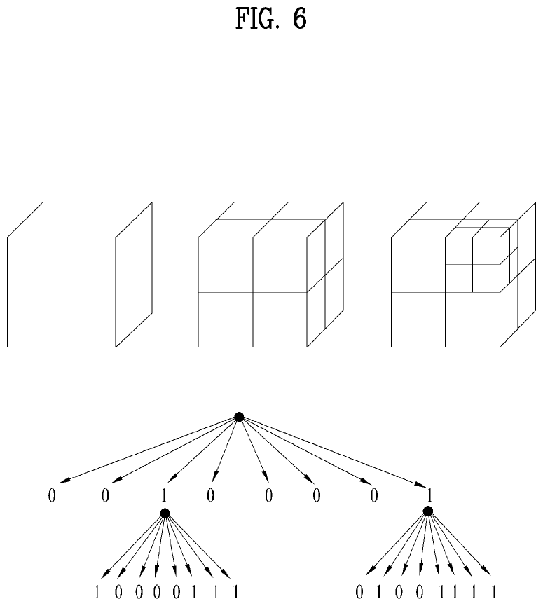

FIG. 6 shows an example of an octree and occupancy code according to embodiments.

As described with reference to FIGS. 1 to 4, the point cloud content providing system (point cloud video encoder 10002) or the point cloud encoder (for example, the octree analyzer 40002) performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}) Here, 2^{d} may be set to a value constituting the smallest bounding box surrounding all points of the point cloud content (or point cloud video). Here, d denotes the depth of the octree. The value of d is determined in the following equation. In the following equation, (x^{int}ₙ, y^{int}ₙ, z^{int}ₙ) denotes the positions (or position values) of quantized points.

d=Ceil(Log 2(Max(xₙ^{int},yₙ^{int},zₙ^{int},n=1, . . . ,N)+1))

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud encoder (for example, the arithmetic encoder 40004) according to the embodiments may perform entropy encoding on the occupancy codes. In order to increase the compression efficiency, the point cloud encoder may perform intra/inter-coding on the occupancy codes. The reception device (for example, the reception device 10004 or the point cloud video decoder 10006) according to the embodiments reconstructs the octree based on the occupancy codes.

The point cloud encoder (for example, the point cloud encoder of FIG. 4 or the octree analyzer 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud encoder according to the embodiments may skip voxelization and perform direct coding to directly code the positions of points included in the specific region. The coordinates of a direct coding point according to the embodiments are referred to as direct coding mode (DCM). The point cloud encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud encoder (or the arithmetic encoder 40004) according to the embodiments may perform entropy coding on the positions (or position values) of the points.

The point cloud encoder (for example, the surface approximation analyzer 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud encoder according to the embodiments may specify a level at which trisoup geometry encoding is to be applied. For example, when the specific level is equal to the depth of the octree, the point cloud encoder does not operate in the trisoup mode. In other words, the point cloud encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud encoder according to the embodiments (for example, the geometry reconstructor 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed by: 1) calculating the centroid value of each vertex, 2) subtracting the center value from each vertex value, and 3) estimating the sum of the squares of the values obtained by the subtraction.

$$\begin{matrix}[ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] & 1 ) \\ [ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] & 2 ) \\ [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ] & 3 )\end{matrix}$$

The minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of θ is estimated through a tan 2(bi, ai), and the vertices are ordered based on the value of θ. The table below shows a combination of vertices for creating a triangle according to the number of the vertices. The vertices are ordered from 1 to n. The table below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

TABLE Triangles formed from vertices ordered 1

TABLE 1

| n | Triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), (7, 9, 3) |
| 10 | (1, 2, 3), (3, 4, 5), (5, 6, 7), (7, 8, 9), (9, 10, 1), (1, 3, 5), (5, 7, 9), |
| | (9, 1, 5) |
| 11 | (1, 2, 3), (3, 4, 5), (5, 6, 7), (7, 8, 9), (9, 10, 11), (11, 1, 3), (3, 5, 7), |
| | (7, 9, 11), (11, 3, 7) |
| 12 | (1, 2, 3), (3, 4, 5), (5, 6, 7), (7, 8, 9), (9, 10, 11), (11, 12, 1), |
| | (1, 3, 5), (5, 7, 9), (9, 11, 1), (1, 5, 9) |

The upsampling process is performed to add points in the middle along the edge of the triangle and perform voxelization. The added points are generated based on the upsampling factor and the width of the block. The added points are called refined vertices. The point cloud encoder according to the embodiments may voxelize the refined vertices. In addition, the point cloud encoder may perform attribute encoding based on the voxelized positions (or position values).

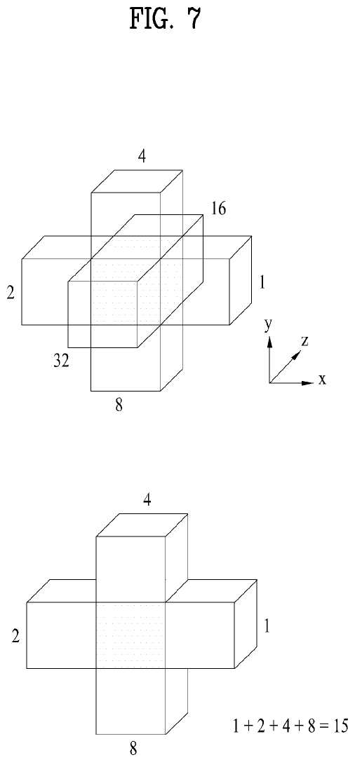

FIG. 7 shows an example of a neighbor node pattern according to embodiments.

In order to increase the compression efficiency of the point cloud video, the point cloud encoder according to the embodiments may perform entropy coding based on context adaptive arithmetic coding.

As described with reference to FIGS. 1 to 6, the point cloud content providing system or the point cloud encoder (for example, the point cloud video encoder 10002, the point cloud encoder or arithmetic encoder 40004 of FIG. 4) may perform entropy coding on the occupancy code immediately. In addition, the point cloud content providing system or the point cloud encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 23=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud encoder according to the embodiments determines occupancy of neighbor nodes of each node of the octree and obtains a value of a neighbor pattern. The neighbor node pattern is used to infer the occupancy pattern of the node. The left part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The right part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud encoder may perform coding according to the neighbor node pattern value (for example, when the neighbor node pattern value is 63, 64 kinds of coding may be performed). According to embodiments, the point cloud encoder may reduce coding complexity by changing a neighbor node pattern value (for example, based on a table by which 64 is changed to 10 or 6).

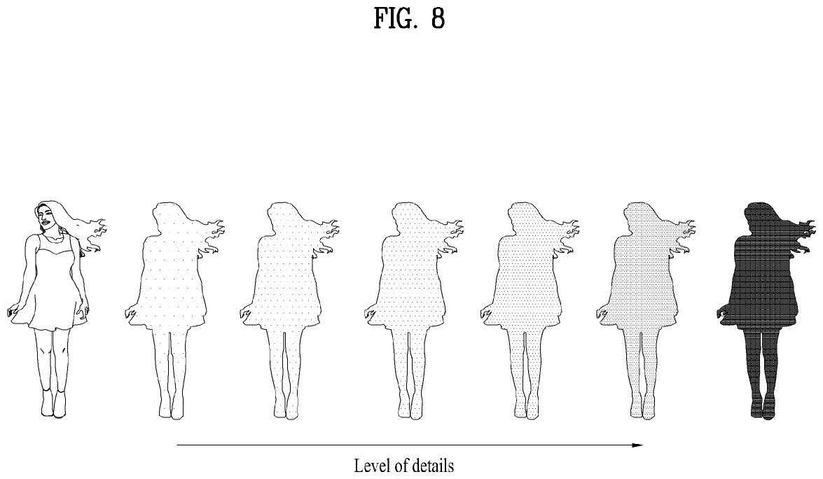

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud encoder (for example, the LOD generator 40009) may classify (reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

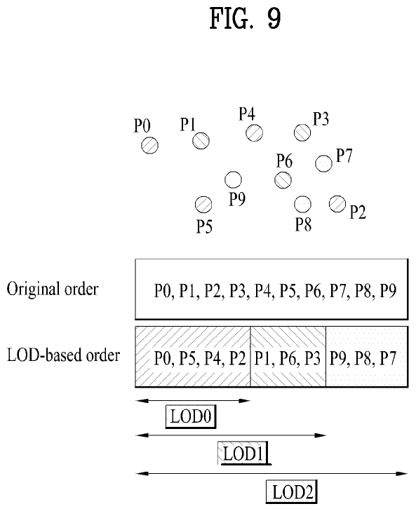

FIG. 9 illustrates an example of point configuration for each LOD according to embodiments.

As described with reference to FIGS. 1 to 8, the point cloud content providing system, or the point cloud encoder (for example, the point cloud video encoder 10002, the point cloud encoder of FIG. 4, or the LOD generator 40009) may generates an LOD. The LOD is generated by reorganizing the points into a set of refinement levels according to a set LOD distance value (or a set of Euclidean distances). The LOD generation process is performed not only by the point cloud encoder, but also by the point cloud decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud encoder according to the embodiments may perform prediction transform coding, lifting transform coding, and RAHT transform coding selectively or in combination.

The point cloud encoder according to the embodiments may generate a predictor for points to perform prediction transform coding for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud encoder according to the embodiments (for example, the coefficient quantizer 40011) may quantize and inversely quantize the residuals (which may be called residual attributes, residual attribute values, or attribute prediction residuals) obtained by subtracting a predicted attribute (attribute value) from the attribute (attribute value) of each point. The quantization process is configured as shown in the following table.

TABLE Attribute prediction residuals quantization pseudo code

TABLE 2

```
int PCCQuantization(int value, int quantStep) {
  if( value >=0) {
    return floor(value / quantStep + 1.0 / 3.0);
  } else {
    return −floor(−value / quantStep + 1.0 / 3.0);
}
}
```

TABLE Attribute prediction residuals inverse quantization pseudo code

TABLE 3

```
int PCCInverseQuantization(int value, int quantStep) {
  if( quantStep ==0)
    return value;
  } else {
    return value * quantStep;
}
}
```

When the predictor of each point has neighbor points, the point cloud encoder (e.g., the arithmetic encoder 40012) according to the embodiments may perform entropy coding on the quantized and inversely quantized residual values as described above. When the predictor of each point has no neighbor point, the point cloud encoder according to the embodiments (for example, the arithmetic encoder 40012) may perform entropy coding on the attributes of the corresponding point without performing the above-described operation.

The point cloud encoder according to the embodiments (for example, the lifting transformer 40010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.

1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud encoder (e.g., coefficient quantizer 40011) according to the embodiments quantizes the predicted attribute values. In addition, the point cloud encoder (e.g., the arithmetic encoder 40012) performs entropy coding on the quantized attribute values.

The point cloud encoder (for example, the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

The equation below represents a RAHT transformation matrix. In the equation, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1x,y,z}}. The weights for gₗ_{_{2x,y,z}} and gₗ_{_{2x+1,y,z}} are w1=wₗ_{_{2x,y,z}} and w2=wₗ_{_{2x+1,y,z}}.

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {g}_{{l}_{2 x + 1 , y , z}}\end{matrix} ⌉ {T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, gₗ₋₁_{_{x,y,z}} is a low-pass value and is used in the merging process at the next higher level. hₗ₋₁_{_{x,y,z}} denotes high-pass coefficients. The high-pass coefficients at each step are quantized and subjected to entropy coding (for example, encoding by the arithmetic encoder 400012). The weights are calculated as wₗ_{_{−1x,y,z}}=wₗ_{_{2x,y,z}}+wₗ_{_{2x+1,y,z}}. The root node is created through the g₁_{_{0,0,0}} and g₁_{_{0,0,1}} as follows.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉$$

The value of gDC is also quantized and subjected to entropy coding like the high-pass coefficients.

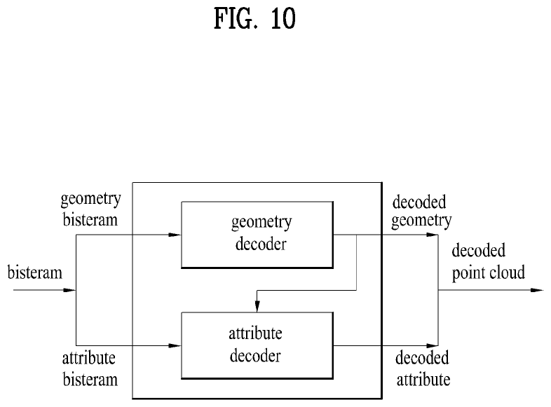

FIG. 10 illustrates a point cloud decoder according to embodiments.

The point cloud decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud decoder may receive a geometry bitstream and an attribute bitstream contained in one or more bitstreams. The point cloud decoder includes a geometry decoder and an attribute decoder. The geometry decoder performs geometry decoding on the geometry bitstream and outputs decoded geometry. The attribute decoder performs attribute decoding based on the decoded geometry and the attribute bitstream, and outputs decoded attributes. The decoded geometry and decoded attributes are used to reconstruct point cloud content (a decoded point cloud).

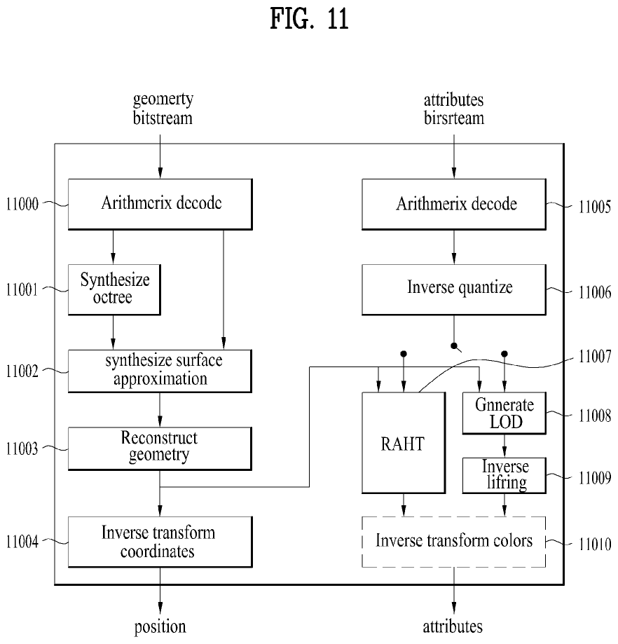

FIG. 11 illustrates a point cloud decoder according to embodiments.

The point cloud decoder illustrated in FIG. 11 is an example of the point cloud decoder illustrated in FIG. 10, and may perform a decoding operation, which is an inverse process of the encoding operation of the point cloud encoder illustrated in FIGS. 1 to 9.

As described with reference to FIGS. 1 and 10, the point cloud decoder may perform geometry decoding and attribute decoding. The geometry decoding is performed before the attribute decoding.

The point cloud decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstructor (Reconstruct geometry) 11003, a coordinate inverse transformer (Inverse transform coordinates) 11004, an arithmetic decoder (Arithmetic decode) 11005, an inverse quantizer (Inverse quantize) 11006, a RAHT transformer 11007, an LOD generator (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstructor 11003, and the coordinate inverse transformer 11004 may perform geometry decoding. The geometry decoding according to the embodiments may include direct coding and trisoup geometry decoding. The direct coding and trisoup geometry decoding are selectively applied. The geometry decoding is not limited to the above-described example, and is performed as an inverse process of the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the inverse process of the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstructor 11003 according to the embodiments may regenerate geometry based on the surface and/or the decoded geometry. As described with reference to FIGS. 1 to 9, direct coding and trisoup geometry encoding are selectively applied. Accordingly, the geometry reconstructor 11003 directly imports and adds position information about the points to which direct coding is applied. When the trisoup geometry encoding is applied, the geometry reconstructor 11003 may reconstruct the geometry by performing the reconstruction operations of the geometry reconstructor 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantizer 11006, the RAHT transformer 11007, the LOD generator 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantizer 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud encoder.

According to embodiments, the RAHT transformer 11007, the LOD generator 11008, and/or the inverse lifter 11009 may process the reconstructed geometry and the inversely quantized attributes. As described above, the RAHT transformer 11007, the LOD generator 11008, and/or the inverse lifter 11009 may selectively perform a decoding operation corresponding to the encoding of the point cloud encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformer 40006 of the point cloud encoder.

Although not shown in the figure, the elements of the point cloud decoder of FIG. 11 may be implemented by hardware including one or more processors or integrated circuits configured to communicate with one or more memories included in the point cloud providing device, software, firmware, or a combination thereof. The one or more processors may perform at least one or more of the operations and/or functions of the elements of the point cloud decoder of FIG. 11 described above. Additionally, the one or more processors may operate or execute a set of software programs and/or instructions for performing the operations and/or functions of the elements of the point cloud decoder of FIG. 11.

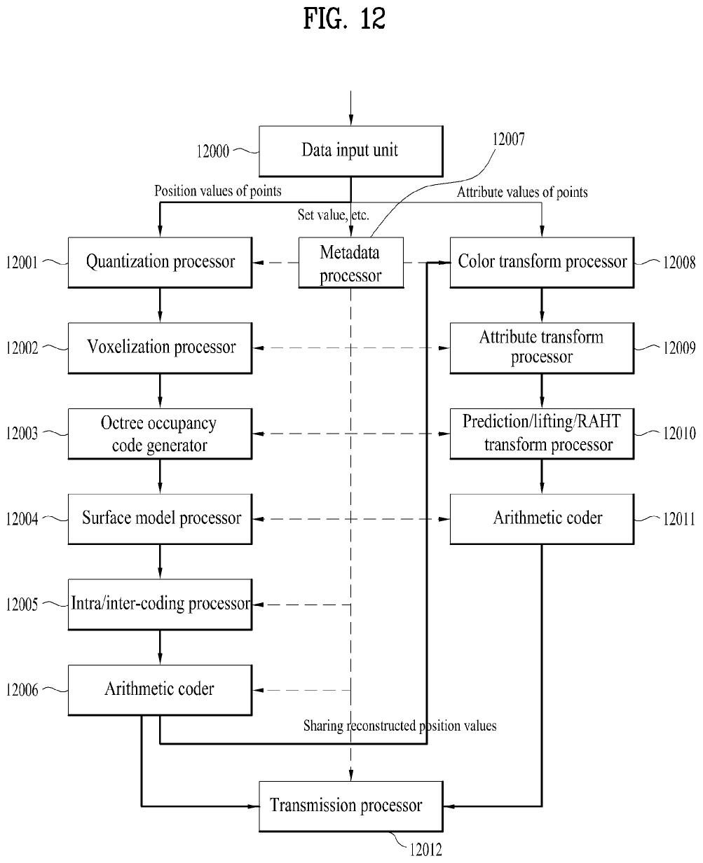

FIG. 12 illustrates an exemplary transmission device according to embodiments.

The transmission device shown in FIG. 12 is an example of the transmission device 10000 of FIG. 1 (or the point cloud encoder of FIG. 4). The transmission device illustrated in FIG. 12 may perform one or more of the operations and methods the same or similar to those of the point cloud encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same or similar to the operation and/or acquisition method of the point cloud video acquirer 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same or similar to the operation and/or quantization of the quantizer 40001 described with reference to FIG. 4. Details are the same as those described with reference to FIGS. 1 to 9.

The voxelization processor 12002 according to the embodiments voxelizes the quantized position values of the points. The voxelization processor 120002 may perform an operation and/or process the same or similar to the operation and/or the voxelization process of the quantizer 40001 described with reference to FIG. 4. Details are the same as those described with reference to FIGS. 1 to 9.

The octree occupancy code generator 12003 according to the embodiments performs octree coding on the voxelized positions of the points based on an octree structure. The octree occupancy code generator 12003 may generate an occupancy code. The octree occupancy code generator 12003 may perform an operation and/or method the same or similar to the operation and/or method of the point cloud encoder (or the octree analyzer 40002) described with reference to FIGS. 4 and 6. Details are the same as those described with reference to FIGS. 1 to 9.

The surface model processor 12004 according to the embodiments may perform trisoup geometry encoding based on a surface model to reconstruct the positions of points in a specific region (or node) on a voxel basis. The surface model processor 12004 may perform an operation and/or method the same or similar to the operation and/or method of the point cloud encoder (for example, the surface approximation analyzer 40003) described with reference to FIG. 4. Details are the same as those described with reference to FIGS. 1 to 9.

The intra/inter-coding processor 12005 according to the embodiments may perform intra/inter-coding on point cloud data. The intra/inter-coding processor 12005 may perform coding the same or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 according to the embodiments performs entropy encoding on an octree of the point cloud data and/or an approximated octree. For example, the encoding scheme includes arithmetic encoding. The arithmetic coder 12006 performs an operation and/or method the same or similar to the operation and/or method of the arithmetic encoder 40004.

The metadata processor 12007 according to the embodiments processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same or similar to the attribute encoding described with reference to FIGS. 1 to 9, and thus a detailed description thereof is omitted.

The color transform processor 12008 according to the embodiments performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same or similar to the operation and/or method of the color transformer 40006 described with reference to FIG. 4 is performed. The detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same or similar to the operation and/or method of the attribute transformer 40007 described with reference to FIG. 4. The detailed description thereof is omitted. The prediction/lifting/RAHT transform processor 12010 according to the embodiments may code the transformed attributes by any one or a combination of RAHT coding, prediction transform coding, and lifting transform coding. The prediction/lifting/RAHT transform processor 12010 performs at least one of the operations the same or similar to the operations of the RAHT transformer 40008, the LOD generator 40009, and the lifting transformer 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 according to the embodiments may encode the coded attributes based on the arithmetic coding. The arithmetic coder 12011 performs an operation and/or method the same or similar to the operation and/or method of the arithmetic encoder 400012.

The transmission processor 12012 according to the embodiments may transmit each bitstream containing encoded geometry and/or encoded attributes and metadata information, or transmit one bitstream configured with the encoded geometry and/or the encoded attributes and the metadata information. When the encoded geometry and/or the encoded attributes and the metadata information according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS) for signaling of a tile level, and slice data. The slice data may include information about one or more slices. One slice according to embodiments may include one geometry bitstream Geom0⁰ and one or more attribute bitstreams Attr0⁰ and Attr1⁰. The TPS according to the embodiments may include information about each tile (for example, coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 according to the embodiments may perform an operation and/or transmission method the same or similar to the operation and/or transmission method of the transmitter 10003. Details are the same as those described with reference to FIGS. 1 and 2, and thus a description thereof is omitted.

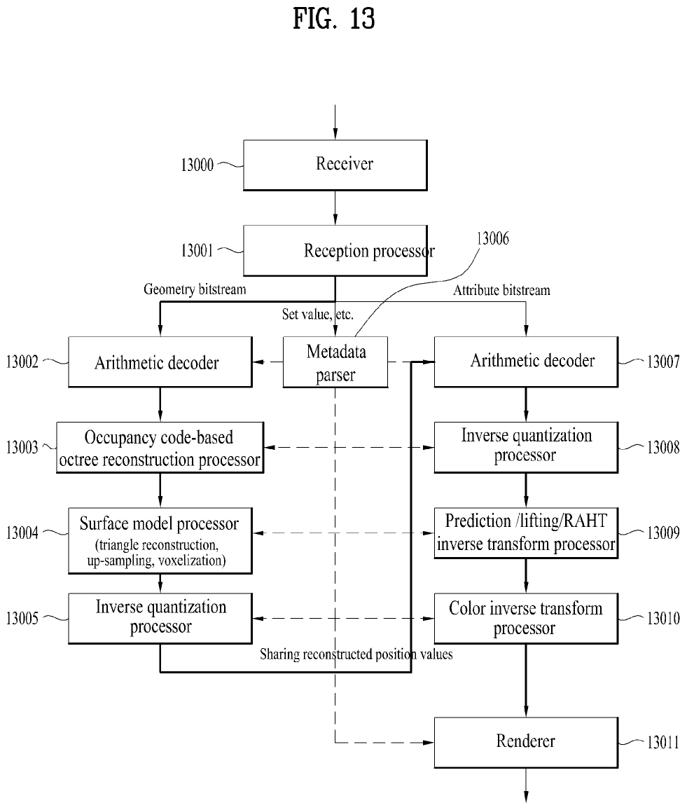

FIG. 13 illustrates an exemplary reception device according to embodiments.

The reception device illustrated in FIG. 13 is an example of the reception device 10004 of FIG. 1 (or the point cloud decoder of FIGS. 10 and 11). The reception device illustrated in FIG. 13 may perform one or more of the operations and methods the same or similar to those of the point cloud decoder described with reference to FIGS. 1 to 11.

The reception device according to the embodiment includes a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform an inverse process of the operation of a corresponding element for encoding according to the embodiments.

The receiver 13000 according to the embodiments receives point cloud data. The receiver 13000 may perform an operation and/or reception method the same or similar to the operation and/or reception method of the receiver 10005 of FIG. 1. The detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 1305 may perform geometry decoding. The geometry decoding according to embodiments is the same or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same or similar to the operation and/or coding of the arithmetic decoder 11000.

The occupancy code-based octree reconstruction processor 13003 according to the embodiments may reconstruct an octree by acquiring an occupancy code from the decoded geometry bitstream (or information about the geometry secured as a result of decoding). The occupancy code-based octree reconstruction processor 13003 performs an operation and/or method the same or similar to the operation and/or octree generation method of the octree synthesizer 11001. When the trisoup geometry encoding is applied, the surface model processor 1302 according to the embodiments may perform trisoup geometry decoding and related geometry reconstruction (for example, triangle reconstruction, up-sampling, voxelization) based on the surface model method. The surface model processor 1302 performs an operation the same or similar to that of the surface approximation synthesizer 11002 and/or the geometry reconstructor 11003.

The inverse quantization processor 1305 according to the embodiments may inversely quantize the decoded geometry.

The metadata parser 1306 according to the embodiments may parse metadata contained in the received point cloud data, for example, a set value. The metadata parser 1306 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same or similar to the attribute decoding described with reference to FIGS. 1 to 10, and thus a detailed description thereof is omitted.

The arithmetic decoder 13007 according to the embodiments may decode the attribute bitstream by arithmetic coding. The arithmetic decoder 13007 may decode the attribute bitstream based on the reconstructed geometry. The arithmetic decoder 13007 performs an operation and/or coding the same or similar to the operation and/or coding of the arithmetic decoder 11005.

The inverse quantization processor 13008 according to the embodiments may inversely quantize the decoded attribute bitstream. The inverse quantization processor 13008 performs an operation and/or method the same or similar to the operation and/or inverse quantization method of the inverse quantizer 11006.

The prediction/lifting/RAHT inverse transformer 13009 according to the embodiments may process the reconstructed geometry and the inversely quantized attributes. The prediction/lifting/RAHT inverse transform processor 1301 performs one or more of operations and/or decoding the same or similar to the operations and/or decoding of the RAHT transformer 11007, the LOD generator 11008, and/or the inverse lifter 11009. The color inverse transform processor 13010 according to the embodiments performs inverse transform coding to inversely transform color values (or textures) included in the decoded attributes. The color inverse transform processor 13010 performs an operation and/or inverse transform coding the same or similar to the operation and/or inverse transform coding of the color inverse transformer 11010. The renderer 13011 according to the embodiments may render the point cloud data.

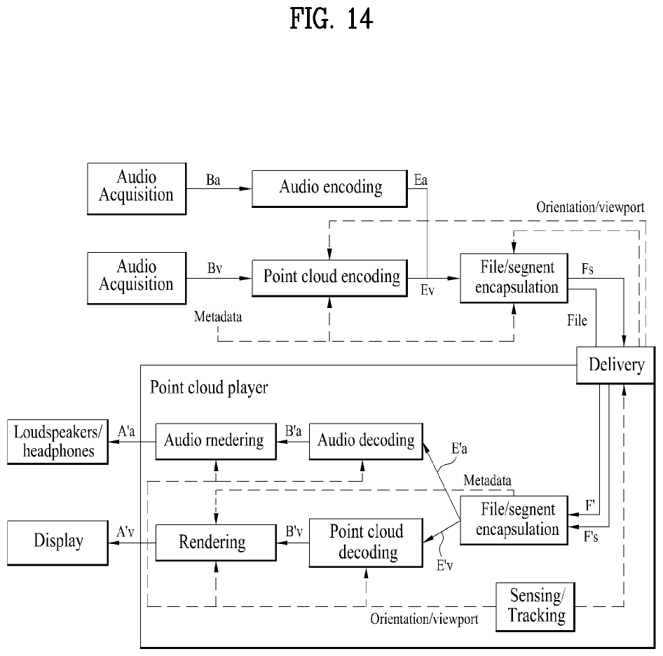

FIG. 14 illustrates an architecture for streaming G-PCC-based point cloud data according to embodiments.

The upper part of FIG. 14 shows a process of processing and transmitting point cloud content by the transmission device described in FIGS. 1 to 13 (for example, the transmission device 10000, the transmission device of FIG. 12, etc.).

As described with reference to FIGS. 1 to 13, the transmission device may acquire audio Ba of the point cloud content (Audio Acquisition), encode the acquired audio (Audio Encoding), and output an audio bitstream Ea. In addition, the transmission device may acquire a point cloud (or point cloud video) By of the point cloud content (Point Acquisition), and perform point cloud encoding on the acquired point cloud to output a point cloud video bitstream Eb. The point cloud encoding of the transmission device is the same or similar to the point cloud encoding described with reference to FIGS. 1 to 13 (for example, the encoding of the point cloud encoder of FIG. 4), and thus a detailed description thereof will be omitted.

The transmission device may encapsulate the generated audio bitstream and video bitstream into a file and/or a segment (File/segment encapsulation). The encapsulated file and/or segment Fs, File may include a file in a file format such as ISOBMFF or a DASH segment. Point cloud-related metadata according to embodiments may be contained in the encapsulated file format and/or segment. The metadata may be contained in boxes of various levels on the ISOBMFF file format, or may be contained in a separate track within the file. According to an embodiment, the transmission device may encapsulate the metadata into a separate file. The transmission device according to the embodiments may deliver the encapsulated file format and/or segment over a network. The processing method for encapsulation and transmission by the transmission device is the same as that described with reference to FIGS. 1 to 13 (for example, the transmitter 10003, the transmission step 20002 of FIG. 2, etc.), and thus a detailed description thereof will be omitted.

The lower part of FIG. 14 shows a process of processing and outputting point cloud content by the reception device (for example, the reception device 10004, the reception device of FIG. 13, etc.) described with reference to FIGS. 1 to 13.

According to embodiments, the reception device may include devices configured to output final audio data and final video data (e.g., loudspeakers, headphones, a display), and a point cloud player configured to process point cloud content (a point cloud player). The final data output devices and the point cloud player may be configured as separate physical devices. The point cloud player according to the embodiments may perform geometry-based point cloud compression (G-PCC) coding, video-based point cloud compression (V-PCC) coding and/or next-generation coding.

The reception device according to the embodiments may secure a file and/or segment F′, Fs′ contained in the received data (for example, a broadcast signal, a signal transmitted over a network, etc.) and decapsulate the same (File/segment decapsulation). The reception and decapsulation methods of the reception device is the same as those described with reference to FIGS. 1 to 13 (for example, the receiver 10005, the reception unit 13000, the reception processing unit 13001, etc.), and thus a detailed description thereof will be omitted.

The reception device according to the embodiments secures an audio bitstream E′ a and a video bitstream v contained in the file and/or segment. As shown in the figure, the reception device outputs decoded audio data B′ a by performing audio decoding on the audio bitstream, and renders the decoded audio data (audio rendering) to output final audio data A′ a through loudspeakers or headphones.

Also, the reception device performs point cloud decoding on the video bitstream E′ v and outputs decoded video data B′ v. The point cloud decoding according to the embodiments is the same or similar to the point cloud decoding described with reference to FIGS. 1 to 13 (for example, decoding of the point cloud decoder of FIG. 11), and thus a detailed description thereof will be omitted. The reception device may render the decoded video data and output final video data through the display.

The reception device according to the embodiments may perform at least one of decapsulation, audio decoding, audio rendering, point cloud decoding, and point cloud video rendering based on the transmitted metadata. The details of the metadata are the same as those described with reference to FIGS. 12 to 13, and thus a description thereof will be omitted.

As indicated by a dotted line shown in the figure, the reception device according to the embodiments (for example, a point cloud player or a sensing/tracking unit in the point cloud player) may generate feedback information (orientation, viewport). According to embodiments, the feedback information may be used in a decapsulation process, a point cloud decoding process and/or a rendering process of the reception device, or may be delivered to the transmission device. Details of the feedback information are the same as those described with reference to FIGS. 1 to 13, and thus a description thereof will be omitted.

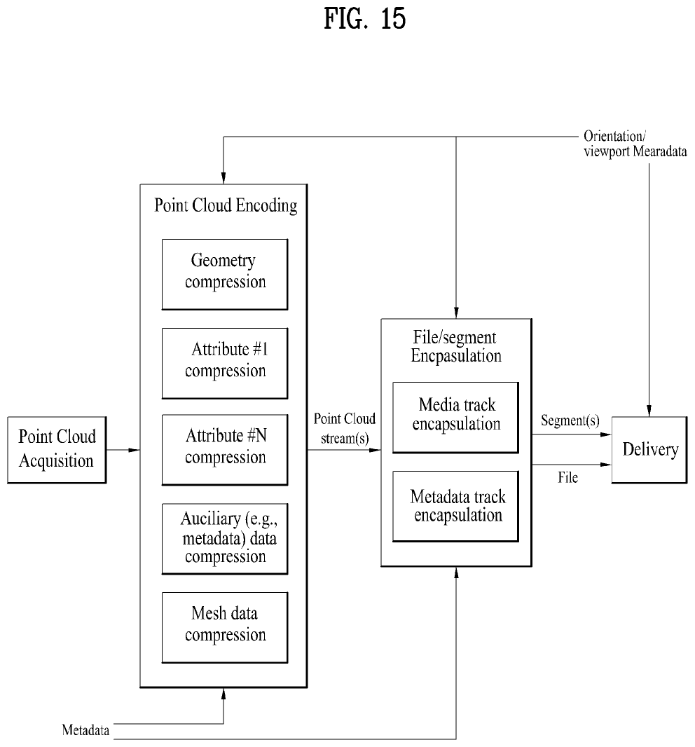

FIG. 15 shows an exemplary transmission device according to embodiments.

The transmission device of FIG. 15 is a device configured to transmit point cloud content, and corresponds to an example of the transmission device described with reference to FIGS. 1 to 14 (e.g., the transmission device 10000 of FIG. 1, the point cloud encoder of FIG. 4, the transmission device of FIG. 12, the transmission device of FIG. 14). Accordingly, the transmission device of FIG. 15 performs an operation that is identical or similar to that of the transmission device described with reference to FIGS. 1 to 14.

The transmission device according to the embodiments may perform one or more of point cloud acquisition, point cloud encoding, file/segment encapsulation and delivery.

Since the operation of point cloud acquisition and delivery illustrated in the figure is the same as the operation described with reference to FIGS. 1 to 14, a detailed description thereof will be omitted.

As described above with reference to FIGS. 1 to 14, the transmission device according to the embodiments may perform geometry encoding and attribute encoding. The geometry encoding may be referred to as geometry compression, and the attribute encoding may be referred to as attribute compression. As described above, one point may have one geometry and one or more attributes. Accordingly, the transmission device performs attribute encoding on each attribute. The figure illustrates that the transmission device performs one or more attribute compressions (attribute #1 compression, . . . , attribute #N compression). In addition, the transmission device according to the embodiments may perform auxiliary compression. The auxiliary compression is performed on the metadata. Details of the metadata are the same as those described with reference to FIGS. 1 to 14, and thus a description thereof will be omitted. The transmission device may also perform mesh data compression. The mesh data compression according to the embodiments may include the trisoup geometry encoding described with reference to FIGS. 1 to 14.

The transmission device according to the embodiments may encapsulate bitstreams (e.g., point cloud streams) output according to point cloud encoding into a file and/or a segment. According to embodiments, the transmission device may perform media track encapsulation for carrying data (for example, media data) other than the metadata, and perform metadata track encapsulation for carrying metadata. According to embodiments, the metadata may be encapsulated into a media track.

As described with reference to FIGS. 1 to 14, the transmission device may receive feedback information (orientation/viewport metadata) from the reception device, and perform at least one of the point cloud encoding, file/segment encapsulation, and delivery operations based on the received feedback information. Details are the same as those described with reference to FIGS. 1 to 14, and thus a description thereof will be omitted.

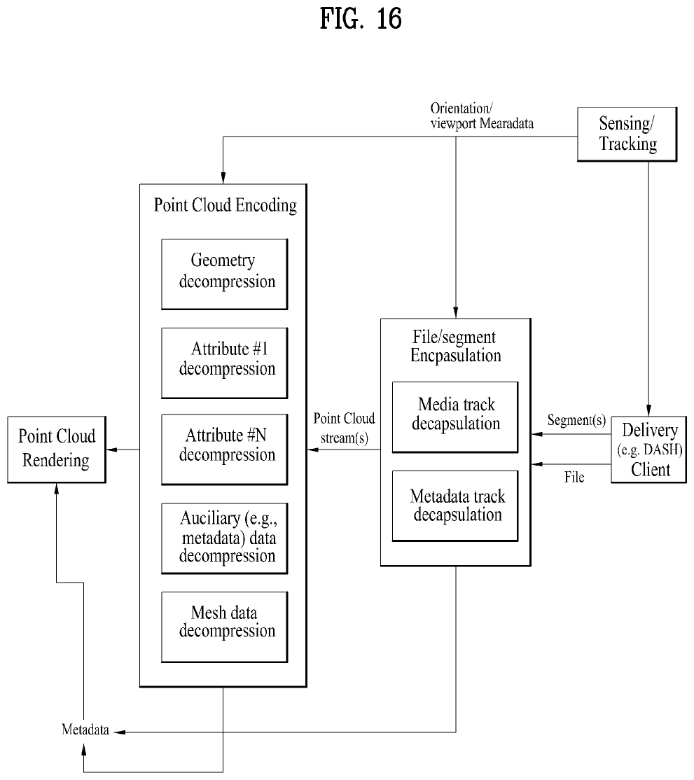

FIG. 16 shows an exemplary reception device according to embodiments.

The reception device of FIG. 16 is a device for receiving point cloud content, and corresponds to an example of the reception device described with reference to FIGS. 1 to 14 (for example, the reception device 10004 of FIG. 1, the point cloud decoder of FIG. 11, and the reception device of FIG. 13, the reception device of FIG. 14). Accordingly, the reception device of FIG. 16 performs an operation that is identical or similar to that of the reception device described with reference to FIGS. 1 to 14. The reception device of FIG. 16 may receive a signal transmitted from the transmission device of FIG. 15, and perform a reverse process of the operation of the transmission device of FIG. 15.

The reception device according to the embodiments may perform at least one of delivery, file/segment decapsulation, point cloud decoding, and point cloud rendering.

Since the point cloud reception and point cloud rendering operations illustrated in the figure are the same as those described with reference to FIGS. 1 to 14, a detailed description thereof will be omitted.

As described with reference to FIGS. 1 to 14, the reception device according to the embodiments decapsulate the file and/or segment acquired from a network or a storage device. According to embodiments, the reception device may perform media track decapsulation for carrying data (for example, media data) other than the metadata, and perform metadata track decapsulation for carrying metadata. According to embodiments, in the case where the metadata is encapsulated into a media track, the metadata track decapsulation is omitted.

As described with reference to FIGS. 1 to 14, the reception device may perform geometry decoding and attribute decoding on bitstreams (e.g., point cloud streams) secured through decapsulation. The geometry decoding may be referred to as geometry decompression, and the attribute decoding may be referred to as attribute decompression. As described above, one point may have one geometry and one or more attributes, each of which is encoded by the transmission device. Accordingly, the reception device performs attribute decoding on each attribute. The figure illustrates that the reception device performs one or more attribute decompressions (attribute #1 decompression, . . . , attribute #N decompression). The reception device according to the embodiments may also perform auxiliary decompression. The auxiliary decompression is performed on the metadata. Details of the metadata are the same as those described with reference to FIGS. 1 to 14, and thus a disruption thereof will be omitted. The reception device may also perform mesh data decompression. The mesh data decompression according to the embodiments may include the trisoup geometry decoding described with reference to FIGS. 1 to 14. The reception device according to the embodiments may render the point cloud data that is output according to the point cloud decoding.

As described with reference to FIGS. 1 to 14, the reception device may secure orientation/viewport metadata using a separate sensing/tracking element, and transmit feedback information including the same to a transmission device (for example, the transmission device of FIG. 15). In addition, the reception device may perform at least one of a reception operation, file/segment decapsulation, and point cloud decoding based on the feedback information. Details are the same as those described with reference to FIGS. 1 to 14, and thus a description thereof will be omitted.

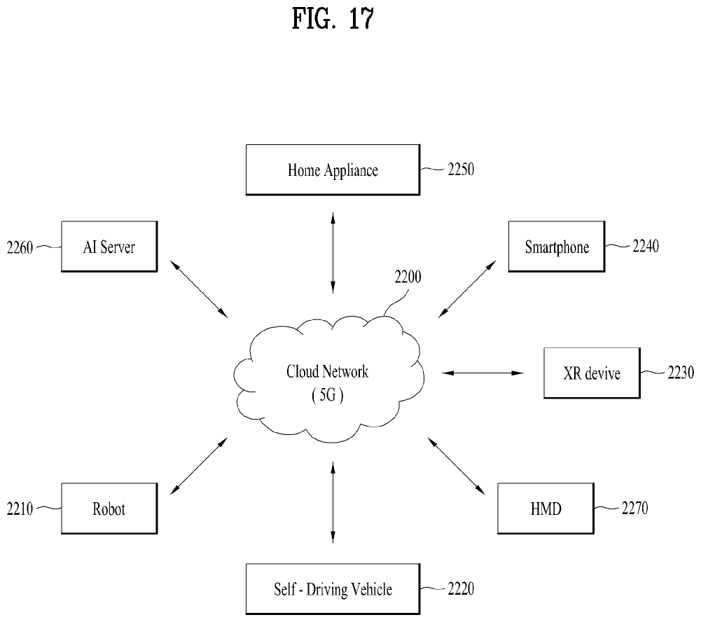

FIG. 17 shows an exemplary structure operatively connectable with a method/device for transmitting and receiving point cloud data according to embodiments.

The structure of FIG. 17 represents a configuration in which at least one of a server 1760, a robot 1710, a self-driving vehicle 1720, an XR device 1730, a smartphone 1740, a home appliance 1750, and/or an HMD 1770 is connected to a cloud network 1700. The robot 1710, the self-driving vehicle 1720, the XR device 1730, the smartphone 1740, or the home appliance 1750 is referred to as a device. Further, the XR device 1730 may correspond to a point cloud data (PCC) device according to embodiments or may be operatively connected to the PCC device.

The cloud network 1700 may represent a network that constitutes part of the cloud computing infrastructure or is present in the cloud computing infrastructure. Here, the cloud network 1700 may be configured using a 3G network, 4G or Long Term Evolution (LTE) network, or a 5G network.

The server 1760 may be connected to at least one of the robot 1710, the self-driving vehicle 1720, the XR device 1730, the smartphone 1740, the home appliance 1750, and/or the HMD 1770 over the cloud network 1700 and may assist at least a part of the processing of the connected devices 1710 to 1770.

The HMD 1770 represents one of the implementation types of the XR device and/or the PCC device according to the embodiments. According to embodiments, an HMD type device includes a communication unit, a control unit, a memory, an I/O unit, a sensor unit, and a power supply unit.

Hereinafter, various embodiments of the devices 1710 to 1750 to which the above-described technology is applied will be described. The devices 1710 to 1750 illustrated in FIG. 17 may be operatively connected/coupled to a point cloud data transmission/reception device according to the above-described embodiments.

<PCC+XR>

The XR/PCC device 1730 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 1730 may analyze 3D point cloud data or image data acquired through various sensors or from an external device and generate position data and attribute data about 3D points. Thereby, the XR/PCC device 1730 may acquire information about the surrounding space or a real object, and render and output an XR object. For example, the XR/PCC device 1730 may match an XR object including auxiliary information about a recognized object with the recognized object and output the matched XR object.

<PCC+Self-Driving+XR>

The self-driving vehicle 1720 may be implemented as a mobile robot, a vehicle, an unmanned aerial vehicle, or the like by applying the PCC technology and the XR technology.

The self-driving vehicle 1720 to which the XR/PCC technology is applied may represent an autonomous vehicle provided with means for providing an XR image, or an autonomous vehicle that is a target of control/interaction in the XR image. In particular, the self-driving vehicle 1720, which is a target of control/interaction in the XR image, may be distinguished from the XR device 1730 and may be operatively connected thereto.

The self-driving vehicle 1720 having means for providing an XR/PCC image may acquire sensor information from the sensors including a camera, and output the generated XR/PCC image based on the acquired sensor information. For example, the self-driving vehicle 1720 may have an HUD and output an XR/PCC image thereto to provide an occupant with an XR/PCC object corresponding to a real object or an object present on the screen.

In this case, when the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap the object on the screen. For example, the self-driving vehicle 1220 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

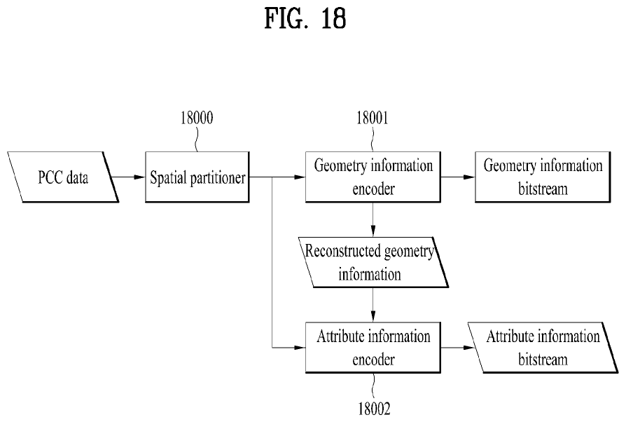

FIG. 18 illustrates a point cloud encoder according to embodiments.

A point cloud encoder according to embodiments receives and encodes point cloud data (PCC data). The point cloud encoder according to the embodiments outputs a geometry information bitstream and an attribute information bitstream. The point cloud encoder according to the embodiments may include a spatial partitioner 18000, a geometry information encoder 18001 and/or an attribute information encoder 18002.

The spatial partitioner 18000 of the point cloud encoder may receive point cloud data (PCC data) and partition the point cloud data into one or more 3D spaces. The spatial partitioner 18001 may receive the point cloud data and spatially partition the point cloud data into 3D blocks. The point cloud data may include geometry information and/or attribute information about a point (or points). The spatial partitioner may spatially partition the PCC data based on a bounding box and/or a sub-bounding box. The method/device according to the embodiments may perform encoding/decoding based on the partitioned unit (box).

The spatial partitioner 18000 may perform part/all of the point cloud acquisition of FIG. 1, the acquisition 20000 of FIG. 2, the operation according to FIGS. 3 to 5, and the operation of the data input unit 12000 of FIG. 12.

The geometry information encoder 18001 receives geometry information of point cloud data (PCC data) according to embodiments and encodes the same. The geometry information may refer to position information about points included in the point cloud data. The geometry information encoder 18001 encodes the geometry information and outputs a geometry information bitstream. The geometry information encoder 18001 may output the reconstructed geometry information by reconstructing the position information about the points. The geometry information encoder 18001 may transmit the reconstructed geometry information to the attribute information encoder 18001.

The geometry information encoder 18001 may perform some/all of the operations of the point cloud video encoder 10002 of FIG. 1, the encoding 20001 of FIG. 2, the coordinate transformer 40000, quantizer 40001, octree analyzer 40002, surface approximation analyzer 40003 arithmetic encoder 40004, geometry reconstructor 40005 of FIG. 4, the quantization processor 12001, voxelization processor 12002, octree occupancy code generator 12003, surface model processor 12004, intra/inter-coding processor 12005, and/or the arithmetic coder 12006 of FIG. 12.

The attribute information encoder 18002 may receive attribute information about point cloud data according to embodiments, and encode the attribute information based on the reconstructed geometry information received from the geometry information encoder 18001. The attribute information encoder 18002 encodes attribute information and outputs an attribute information bitstream. The attribute information encoder 18002 may perform, for example, a prediction transform, a lifting transform, and/or a region adaptive hierarchical transform (RAHT) according to embodiments. The attribute information encoder 18002 may perform, for example, a prediction lifting transform. The prediction lifting transform may mean combining some or all of the detailed operations of the prediction transform and/or lifting transform according to the embodiments.

The point cloud encoder according to the embodiments may perform encoding with some or all of the prediction transform, the lifting transform, and/or the RAHT transform according to the embodiments, and/or a combination thereof.

The attribute information encoder 18002 may perform all/part of the operations of the point cloud video encoder 10002 of FIG. 1, the encoding 20001 of FIG. 2, the color transformer 40006, attribute transformer 40007, RATH transformer 40008, LOD generator 40009, lifting generator 40010, coefficient quantizer 40011 and/or arithmetic encoder 40012 of FIG. 4, the color transform processor 12008, attribute transform processor 12009, prediction/lifting/RAHT transform processor 12010 and arithmetic coder 12011 of FIG. 12.

Here, the reconstructed geometry information may represent an octree reconstructed by the geometry reconstructor (Reconstruct Geometry) 40005 and/or an approximated octree described with reference to FIG. 4. The reconstructed geometry information may represent the occupancy code described with reference to FIG. 6 or the octree structure. The reconstructed geometry information may represent an octree occupancy code generated by the octree occupancy code generator 12003 described with reference to FIG. 12.

The attribute information encoder 18002 may encode attribute information about point cloud data according to embodiments. Here, the encoder 18002 according to the embodiments may encode the attribute information based on the reconstructed geometry information according to the embodiments. The attribute information encoder 18002 may encode the received data to generate a bitstream containing the attribute information.

The attribute information encoder 18002 according to the embodiments may include the color transformer 40006, the attribute transformer 40007, the RAHT transformer 40008, the LOD generator 40009, the lifting unit 40010, the quantizer 40011, and/or an arithmetic encoder 40012 of FIG. 4. However, when the attribute information about the point cloud data is encoded according to FIG. 4 or FIG. 12, the image quality of some point cloud data may be deteriorated. This is because, in the process of encoding the attribute information about the point cloud data according to the embodiments, attribute information about some points may be lost.

For example, the point cloud data transmission/reception device according to the embodiments predicts attribute information about specific points by the prediction technique or the lifting technique, and transmits or renders the predicted attribute information. In this case, the prediction of the attribute information is generated based on the distance of the points and the attribute information thereon for efficiency of transmission and reception of point cloud data, and there is no process of correcting the attribute information after the attribute information is predicted.

Such prediction is based on the assumption that the values of the attribute information are similar as the distance between the points is closer. Accordingly, if the attribute information about the point cloud data is irregularly distributed or the data has a large difference in attribute value among the points at a close distance, the image quality may be greatly deteriorated.

Accordingly, the point cloud data transmission device (or the attribute information encoder 18002) according to the embodiments may compress and transmit an error (e.g., residual information) generated in reconstructing the attribute information according to the embodiments. The point cloud data transmission device according to the embodiments may further include an attribute reconstruction error compressor.

A method of transmitting point cloud data according to embodiments may include encoding point cloud data and/or transmitting a bitstream containing the point cloud data and signaling information.

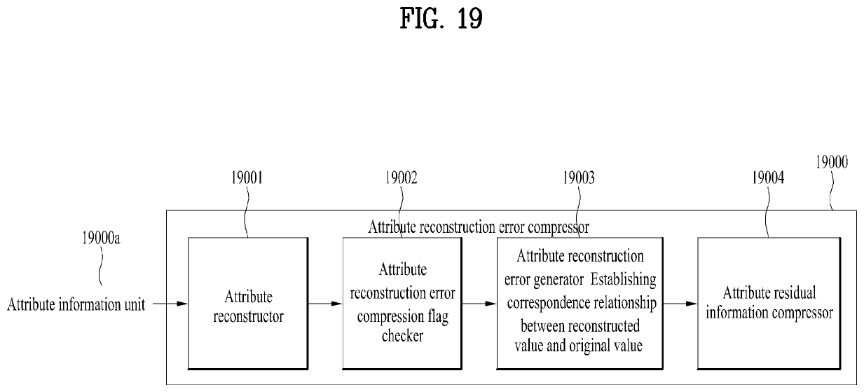

FIG. 19 illustrates an attribute reconstruction error compressor according to embodiments.

According to embodiments, an attribute reconstruction error compressor 19000 may receive attribute information unit 19000a. Upon receiving the attribute information unit 19000a, the attribute reconstruction error compressor 19000 generates compressed attribute residual information. According to embodiments, the attribute reconstruction error compressor 19000 may be included in, for example, the attribute information encoder 18002 of FIG. 18.

The attribute reconstruction error compressor 19000 may include an attribute reconstructor 19001, an attribute reconstruction error compression flag checker 19002, an attribute reconstruction error generator 19003, and/or an attribute residual value compressor 19004.

The attribute reconstructor 19001 receives the attribute information unit 19000a, and reconstructs the attribute information in the attribute information unit. The attribute information unit 19000a according to the embodiments refers to a unit of attribute information in which reconstruction error compression of attribute information according to the embodiments is performed. For example, the attribute information unit 19000a may be attribute information corresponding to one 3D block or a bundle of two or more 3D blocks or a set thereof. The attribute information unit may be a unit in which reconstruction error compression of attribute information partitioned through a spatial partitioner (e.g., the spatial partitioner 18000 of FIG. 18) is to be performed. The attribute information unit 19000a may be transformed attribute information (e.g., the attribute information transformed by the RAHT 40008 and/or the attribute information transformed by the lifting 40010) according to embodiments.

The attribute information reconstructor 19001 may use the same method as the reconstruction method (e.g., decoding) used by the attribute information decoder of the PCC reception device according to the embodiments. The attribute information reconstructor 19001 according to the embodiments may generate reconstructed attribute information.

The attribute reconstruction error compression flag checker 19002 may determine whether the attribute reconstruction error compressor is to compress the attribute reconstruction error. According to embodiments, the reconstructed attribute information generated by the attribute reconstructor 19001 may be different from the original attribute information. This difference may be referred to as an attribute reconstruction error. The attribute reconstruction error compression flag checker 19002 may determine whether to compress the attribute reconstruction error and generate information (or a flag) indicating whether to compress the attribute reconstruction error. This information may be the parameter attribute_rec_error_flag according to embodiments, which will be described later.

According to embodiments, in performing reconstruction error compression, the attribute reconstruction error compression flag checker 19002 may determine whether to perform reconstruction error compression based on information such as the size of the unit, the value inside the unit, the relationship with neighboring units, the relationship between the original value of the unit and the reconstructed value, the range of attribute information of the unit, and/or gp.

According to embodiments, when a unit for which attribute information of the original unit is in the range of 15 to 254 is reconstructed in a range of 0 to 254, the attribute reconstruction error compression flag checker 19002 may perform attribute reconstruction error compression only on reconstructed values in the range of 0 to 14 within the unit.

When the reconstruction error compression of the attribute information is performed, the attribute reconstruction error generator 19003 may establish a correspondence relationship between the reconstructed attribute information and the original attribute information according to the embodiments and generate an attribute reconstruction error. Here, the correspondence relationship indicates how the reconstructed attribute information and the original attribute information are mapped to each other. That is, the attribute reconstruction error generator may generate information indicating the correspondence relationship. The attribute reconstruction error generator may be referred to as a part to establish a correspondence relationship between a reconstructed value and an original value, a correspondence establisher, or the like.

According to embodiments, the attribute reconstruction error may be information (i.e., residual information) indicating a difference between the reconstructed attribute information and attribute information (i.e., original attribute information) about points of the point cloud data.

For example, when the value of the attribute information for a specific point is 13 and the value of the reconstructed attribute information is 20, information indicating a correspondence between 13, which is the original attribute value for the attribute reconstruction error generator, and 20, which is the reconstructed attribute information value.

Here, when the position information is losslessly compressed, the value of the position information does not change. Accordingly, a relationship may be established between the original attribute value and the reconstructed attribute value of each point in a one-to-one correspondence. However, when the position information is lossy compressed, the original position information value is not equal to the reconstructed position information value. Accordingly, various correspondence relationship establishment algorithms to establish correspondence therebetween may be used.

According to embodiments, algorithms used to establish a correspondence relationship may include various nearest-neighbor search algorithms and a minimum error point search algorithm using MES.

According to embodiments, the PCC transmission device may transmit information indicating a correspondence relationship establishment algorithm executed by the attribute reconstruction error generator. The information indicating the correspondence relationship establishment algorithm may include information indicating an algorithm used by the attribute information encoder according to the embodiments (e.g., a corresponded_relationship_algorithm_index parameter, which will be described later). According to embodiments, an algorithm used to establish a correspondence relationship may be fixed to a specific algorithm according to a characteristic of a unit.

The attribute residual value compressor 19004 may compress the attribute reconstruction error generated by the attribute reconstruction error generator. The attribute residual value compressor may be referred to as an attribute residual information compressor, an attribute residual compressor, or the like. Residual value compression may be performed using arithmetic coding. The attribute residual value compressor may be operated according to the operation of the arithmetic coding 40012 of FIG. 4.

<Attribute Reconstruction Error Compressor: Position Information Unit>

According to embodiments, reconstruction error compression may be performed on a part or the entirety of one attribute information unit 19000a. The attribute information of the attribute information unit 19000a according to embodiments may include information such as reflectance and transparence as well as color values of R, G, and B. According to embodiments, the attribute information unit 19000a may be a bundle of data (e.g., tile, slice, frame). The attribute information may be used to improve the point cloud visualization quality.

The attribute information unit 19000a may be changed flexibly (e.g., in units of tile, slice, and frame) according to the settings of the point cloud encoder and the point cloud decoder. The point cloud data transmission device (or the attribute reconstruction error compressor 19000) according to the embodiments may generate information such as the size of an attribute information unit (e.g., attribute_rec_error_unit_size) for indicating a unit to perform reconstruction error compression, and may transmit the same to the point cloud data reception device according to the embodiments.

<Attribute Reconstruction Error Compressor: Checking Whether the Attribute Reconstruction Error Compression Flag is Present>

Once the unit of the attribute information unit 19000a is determined, the attribute reconstructor 19001 according to the embodiments reconstructs attribute information for each unit. According to the embodiments, in the attribute information reconstruction operation of the attribute information reconstructor 19001, reconstruction (e.g., decoding) may be performed according to the same method as the reconstruction method used by the point cloud decoder according to the embodiments. The attribute reconstructor 19001 according to the embodiments may generate reconstructed attribute information obtainable by the point cloud decoder according to the embodiments.

<Attribute Reconstruction Error Compressor: Checking Whether the Attribute Reconstruction Error Compression Flag is Present>

Once the attribute information of the attribute information units 19000a is reconstructed by the attribute reconstructor 19001, the attribute reconfiguration error compression flag checker 19002 according to the embodiments checks whether to perform reconstruction error compression on the attribute information for each attribute information unit 19000a.

Information (attribute_rec_error_flag) on whether to perform reconstruction error compression on attribute information for a specific attribute information unit 19000a according to the embodiments may be transmitted from the point cloud encoder. In performing reconstruction error compression on the attribute information, a specific value may be calculated based on information such as the size of the unit, the value inside the unit, the relationship with neighboring units, the relationship between the original value of the unit and the reconstructed value, the range of attribute information of the unit, and gp, and then it is determining whether to perform the reconstruction error compression according to the value.

According to embodiments, attribute_rec_error_flag may be transmitted from the point cloud encoder on a per leaf node basis, and the point cloud decoder according to the embodiments may recognize whether to perform filtering for each leaf node based on the flag.

<Attribute Reconstruction Error Compressor: Establishing a Correspondence Relationship Between Reconstructed Values and Original Values>

The attribute reconstruction error generator 19003 according to the embodiments establishes a correspondence relationship between the reconstructed attribute information according to the embodiments and the original attribute information. For example, when the position information is losslessly compressed, the value of the position information does not change. Accordingly, a relationship may be established between the original attribute value and the reconstructed attribute value of each point in a one-to-one correspondence. For example, when the position information is lossy compressed, the original position information value is not equal to the reconstructed position information value. Accordingly, various correspondence relationship establishment algorithms to establish correspondence therebetween may be used.

The attribute reconstruction error generator 19003 according to the embodiments may establish the correspondence relationship between the reconstruction information (reconstruction information of the attribute information) and the original attribute information based on various nearest-neighbor search algorithms, and a minimum error point search algorithm using MES, and the like.

The attribute reconstruction error generator 19003 according to the embodiments may generate information on an algorithm for establishing a correspondence relationship according to embodiments. Information (e.g., corresponded_relationship_algorithm_index) indicating a correspondence relationship establishment algorithm used by the point cloud encoder according to the embodiments may be transmitted to the point cloud data decoder. As the correspondence relationship establishment algorithm, a specific algorithm may be fixedly used according to the characteristic of the attribute information unit 19000a.

<Attribute Reconstruction Error Compressor: Attribute Residual Value Compressor (19004)>

When a correspondence relationship is established between the original attribute information of the attribute information unit and the attribute information reconstructed by the attribute reconstructor 19004, the attribute residual information compressor 19004 according to the embodiments calculate and generate a difference value between the original information and the corresponding attribute information, and compress the generated difference value (i.e., residual information). For the residual information according to the embodiments, a residual value is compressed using various residual compression schemes. For example, for compressing the residual value, attribute residual information compression using an arithmetic coding method may be performed. In this case, various arithmetic coding techniques such as run length encoding and entropy encoding may be used as the arithmetic coding method.

According to embodiments, in performing attribute residual value compression using the arithmetic coding method, the quality of a compression result may be determined using quantization coefficients before these arithmetic coding techniques are applied. In particular, the quantization coefficients may be used adaptively to change the quality using different coefficient values according to the characteristics (e.g. distribution, range, variance, etc.) of the attribute values.

According to embodiments, when the arithmetic coding techniques used by the encoder are not the arithmetic coding techniques used by the existing encoder, information (attribute_residual_arithmetic_coding_index) indicating an employed arithmetic coding technique may be transmitted to the decode, and a specific algorithm may be fixedly used according to the characteristics of the attribute residual values.

According to embodiments, when a quantization coefficient is used in performing the attribute residual value compression using a arithmetic coding technique, information on the quantization coefficient used by the encoder (attribute_residual_quantization_parameter) may be transmitted to the decoder. In this regard, specific coefficients may be fixedly used according to the characteristics of the attribute residual values.

According to embodiments, in another embodiment of compressing the residual value, attribute residual value compression may be performed using an attribute value correspondence table. The attribute value correspondence table supports changing the value in each range to a value that may improve the quality, in consideration of the characteristics of the correspondence relationship between the original attribute value and the reconstructed attribute value.

According to the embodiments, for example, in performing the attribute residual value compression using the attribute value correspondence table, the correspondence relationship between the original attribute value and the reconstructed attribute value may be represented as a probability, and an attribute value distribution table may be created such that the value in each range may be changed to a most frequently changed attribute value.

According to embodiments, in this case, various arithmetic coding techniques may be used for the attribute value correspondence table, and information (attribute_corresponded_table_arithmetic_coding_index) signaling an arithmetic coding technique used by the encoder may be transmitted to the decoder.

A method of transmitting point cloud data according to embodiments may include encoding the point cloud data and/or transmitting a bitstream containing the point cloud data and signaling information.

The error compression by the point cloud data transmission device according to the embodiments may include: reconstructing encoded attribute information; determining whether to compress an attribute reconstruction error based on the reconstructed attribute information; when the attribute reconstruction error is compressed, determining a correspondence relationship between the reconstructed attribute information and attribute information about points of the point cloud data and generating an attribute reconstruction error; and compressing the attribute reconstruction error. Here, the attribute reconstruction error may indicate a residual between the reconstructed attribute information and the attribute information about the points of the point cloud data.

Further, according to embodiments, the method of transmitting point cloud data may further include determining a performance unit of attribute information for performing the compression of the attribute reconstruction error. In the compression of the attribute reconstruction error, the attribute reconstruction error of attribute information included in the performance unit of the attribute information may be compressed. The performance unit of the attribute information may be one or more 3D blocks including one or more pieces of attribute information. Also, the signaling information may include information on the performance unit of the attribute information.

As the point cloud data transmission device according to the embodiments further includes the attribute reconstruction error compressor 19000, it may prevent loss of attribute information about some points in the process of encoding the attribute information about the point cloud data according to the embodiments. When the reception device according to the embodiments decodes the point cloud data, the error rate of the data may be reduced by adding or subtracting information that cannot be present as an attribute of the original point cloud data. In addition, the attribute range may be variably clipped according to the characteristics of the data such that the attribute is present only in a specific range. Thereby, the attribute information may be efficiently decoded.

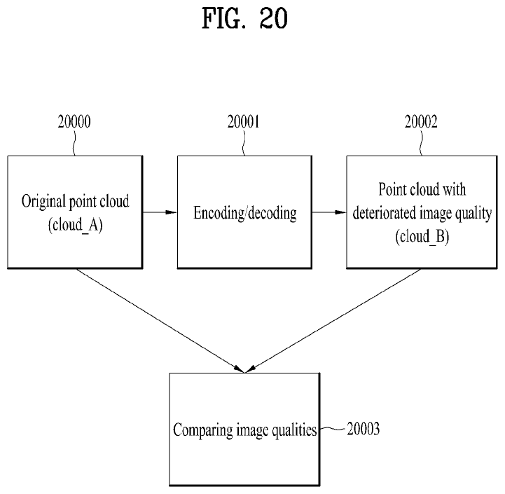

FIG. 20 illustrates a process of improving the image quality of a point cloud by an attribute reconstruction error compressor according to embodiments.

FIG. 20 illustrates a process in which an attribute reconstruction error compressor compares image qualities by comparing attribute information about an original point cloud with attribute information about a point cloud with degraded image quality according to embodiments; The operations shown in FIG. 20 may be performed by the attribute reconstruction error compressor (or the attribute reconstruction error generator) described with reference to FIG. 19.

The process of improving the image quality of the point cloud by the attribute reconstruction error compressor according to the embodiments may include receiving an original point cloud cloud_A (20000), performing encoding and decoding (20001), extracting a point cloud with deteriorated image quality (20002), and/or comparing the image qualities (20003).

The image quality of the point cloud data may be deteriorated during the encoding operation of the point cloud data transmission/reception device according to embodiments.

The point cloud data transmission/reception device may undergo data loss for points corresponding to a boundary of the point cloud data. In order to prevent such deterioration of image quality and/or data loss, the point cloud data transmission device according to the embodiments may add a patch to a boundary region of the encoded point cloud data (e.g., the point cloud data with deteriorated image quality). Adding a patch to the boundary region may be referred to as patch expansion.

Accordingly, the point cloud data transmission device according to the embodiments may detect the boundary of the point cloud data and add a patch to the boundary region in order to prevent deterioration of the image quality of the point cloud data. The boundary may represent a set of points having a large difference from the attribute information about neighboring points among the points of the point cloud data. The patch refers to adding, to positions adjacent or close to the boundary, attribute information close to the attribute information about the points present at the boundary. That is, the point cloud data transmission device according to the embodiments may minimize errors that may occur in the encoding process by encoding the point cloud data obtained by adding the patch to the boundary region.

According to embodiments, after the point cloud data is encoded, the point cloud data transmission device may detect a boundary of the encoded point cloud data and add a patch to the boundary region in order to prevent deterioration of the image quality of the point cloud data. That is, the point cloud data transmission device according to the embodiments may provide natural point cloud content by adding a patch to the boundary region of the point cloud data obtained by performing encoding.

The point cloud data transmission/reception device according to embodiments may improve the image quality based on a color smoothing method. In the point cloud data according to embodiments, attribute information about points may be distorted or the image quality of the data may be deteriorated after decoding is performed. For example, a region having a large difference in attribute information may be present in a specific region of the point cloud data. Since such a region has a large difference in attribute information from neighboring regions, it may be decoded into unnatural point cloud content. Accordingly, the region having a large difference in attribute information from the neighboring regions may be overlaid with a similar color.

In operation 20000 of receiving the original point cloud, the original point cloud cloud_A may be received. Here, the original point cloud cloud_A may represent attribute information before encoding of the points of the point cloud data included in the attribute information unit 19000 described with reference to FIG. 19. The original point cloud may include attribute information about the unencoded original points.

For example, the original point cloud cloud_A may be a set of points including original attribute information about the point cloud video data acquired according to FIG. 1. For example, the original point cloud may represent the original attribute information before being transformed into the attributes shown in FIG. 4 by the RAHT 40008 or the LOD generator 40009 and the lifting transformer 40010. For example, the original point cloud may represent original attribute information before being transformed by the prediction/lifting/RAHT transform processor 12010 of FIG. 12.

In the encoding and decoding operation 20001, the received original point cloud cloud_A may be encoded and then decoded. The encoding and decoding operation 20001 may include encoding and decoding the original point cloud.

Here, the encoding operation includes encoding the attribute information about the original point cloud. For example, in the encoding operation, all/part of the operations of RATH 40008, LOD generation 40009, lifting 40010, quantization 40011, and/or arithmetic encoding 40012 described with reference to FIG. 4, and the operations of the attribute transform processor 12009, prediction/lifting/RAHT transform processor 12010, and/or arithmetic coder 12011 described with the reference to FIG. 12. Here, in the decoding operation, the attribute information about the encoded original point cloud is decoded.

In operation 20002 of extracting point cloud cloud_B with deteriorated image quality, a point cloud with the deteriorated image quality generated by the encoding and decoding operations is extracted. Here, the point cloud data generated by the encoding and decoding operations may have lower image quality than the original point cloud.

The encoding and decoding operation 20001 and the operation 20002 of extracting point cloud cloud_B with deteriorated image quality may be performed by the attribute reconstructor 19001 described with reference to FIG. 19.

In operation 20003 of comparing the image qualities (20003), the original point cloud cloud_A is compared with the point cloud cloud_B with deteriorated image quality. In the operation of comparing the image qualities, the original point cloud cloud_A may be compared with the point cloud cloud_B with the deteriorated image quality, and an encoding error generated by the encoding and decoding may be calculated. Here, the encoding error may refer to the attribute reconstruction error described with reference to FIG. 19. That is, the operation 20003 of comparing the image qualities may be performed by the attribute reconstruction error generator of FIG. 19, and the encoding error may mean the attribute reconstruction described with reference to FIG. 19.

According to embodiments, the operation 20003 of comparing the image qualities may be performed based on the following criteria. For example, two methods are used as methods for image quality evaluation. In the following description, cloud_A is defined as a set of points for the original cloud, and cloud_B is defined as a point cloud with deteriorated image quality.

Original Point Cloud(cloud_{A})={(vᵢ): i=0 . . . K−1}

Degraded Point Cloud(cloud_{B})={(vᵢ): i=0 . . . N−1}

When the sum of the Hausdorff distances between all points vi of cloud_A and all points vi of cloud_B is eA,B, the equation representing a degree related to the image qualities of the two point clouds as PSNR may be given as follows.

$${PSNR}_{cloud A , B} = 10 {log}_{10} \frac{{p}^{2}}{{e}_{A , B}}$$

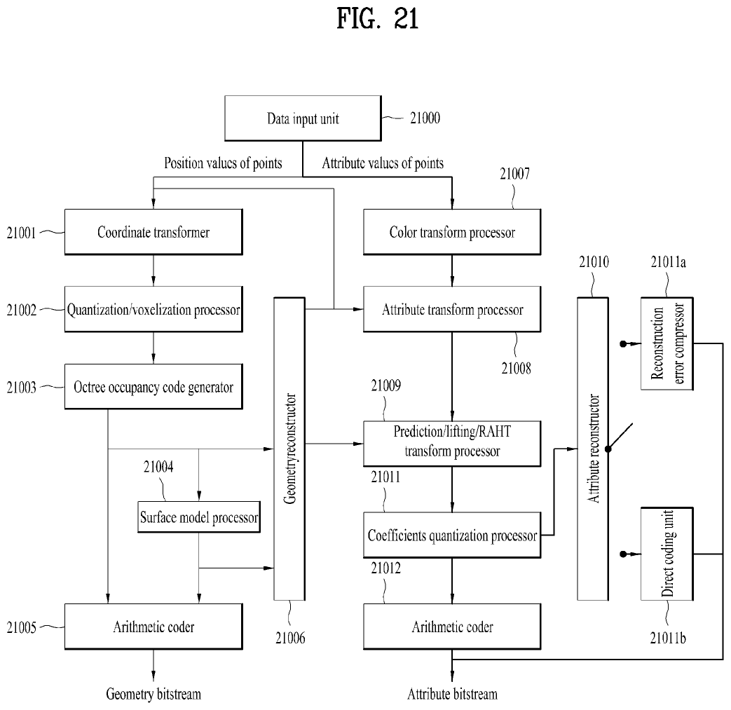

FIG. 21 illustrates a point cloud data encoder including an attribute reconstruction error compressor according to embodiments.

The point cloud data encoder according to the embodiments may include a data input unit 21000, a coordinate transformer 21001, a quantization/voxelization processor 21002, an octree occupancy code generator 21003, a surface model processor 21004, a first arithmetic coder 21005, a geometry reconstructor 21006, a color transform processor 21007, an attribute transform processor 21008, a prediction/lifting/RAHT transform processor 21009, a coefficient quantization processor 21009, an attribute reconstructor 21010, a reconstruction error compressor 21011a, a direct coding unit 21011b, and/or a second arithmetic coder 21012.

The data input unit 21000, the coordinate transformer 21001, the quantization/voxelization processor 21002, the octree occupancy code generator 21003, the surface model processor 21004, the first arithmetic coder 21005, and/or the geometry reconstructor 21006 according to the embodiments may be included in the geometry information encoder 18001 described with reference to FIG. 18. The color transform processor 21007, the attribute transform processor 21008, the prediction/lifting/RAHT transform processor 21009, the coefficient quantization processor 21009, the attribute reconstructor 21010, the reconstruction error compressor 21011a, the direct coding unit 21011b, and/or the second arithmetic coder 21012 according to the embodiments may be included in the attribute information encoder 18002 described with reference to FIG. 18.

The data input unit 21000 receives the acquired point cloud data. The point cloud data may be generated by the point cloud video acquirer or the like. The data input unit 21000 may receive, for example, the point cloud data described with reference to FIG. 3. The data input unit may represent, for example, the data input unit 12000 of FIG. 12.

The coordinate transformer 21001 receives position information about the received point cloud data and transforms the position information into coordinates. The coordinate transformer may perform, for example, the operation of the coordinate transformer (Transform coordinates) 40000 described and illustrated in FIG. 4, and the operation described in FIG. 5.

The quantization/voxelization processor 21002 performs quantization and/or voxelization on the position information about the points transformed by the coordinate transformer. The quantization/voxelization processor may perform the operation of the quantization and voxelization 40001 of FIG. 4 and the operation described with reference to FIG. 5. The quantization/voxelization processor may represent the voxelization processor 12002 described with reference to FIG. 12.

The octree occupancy code generator 21003 generates an octree occupancy code from the position information about the points quantized and voxelized by the quantization/voxelization processor. The octree occupancy code generator may perform the operation of the octree analyzer 40002 described with reference to FIG. 4 and/or the operation described with reference to FIG. 6. The octree occupancy code generator may represent the octree occupancy code generator 12003 described with reference to FIG. 12.

The surface model processor 21004 may process the surface model using the generated octree occupancy code. The surface model processor may perform all/part of the operation of the Analyze surface approximation 40003 described with reference to FIG. 4. The surface model processor may represent the surface model processor 12004 described with reference to FIG. 12.

The first arithmetic coder 21005 may entropy-code the octree occupancy code generated by the octree occupancy code generator and/or the octree occupancy code surface model-processed by the surface model processor. The first arithmetic coder may represent the arithmetic encoding 40004 described with reference to FIG. 4. The first arithmetic coder may perform the operation of the arithmetic coder 12006 described with reference to FIG. 12.

The geometry reconstructor 21006 may reconstruct the geometry based on the octree occupancy code generated by the octree occupancy code generator and/or the surface model-processed octree occupancy code generated by the surface model processor. That is, the geometry reconstructor may reconstruct the octree/voxel based on a result of analysis of the distribution of points. The geometry reconstructor 21006 may perform the operation of the geometry reconstructor (Reconstruct geometry) 40005 described with reference to FIG. 4.

The color transform processor 21007 may receive attribute information about the points of the point cloud data received by the data input unit and transform color values (or texture) included in the attributes. The color transform processor may perform, for example, the operation of the color transformer 40006 described with reference to FIG. 4.

The attribute transform processor 21008 may transform the attribute information transformed by the color transform processor based on the reconstructed geometry information. For example, the attribute transformer may transform the attribute value of a point at a position based on the position value of the point included in the voxel. The attribute transform processor 21008 may perform the operation of the attribute transform (Transfer attributes) 40007 described with reference to FIG. 4.

The prediction/lifting/RAHT transform processor 21009 may perform RAHT, lifting transform, and/or prediction transform on the attribute information transformed by the attribute transformation processor based on the reconstructed geometry information. The prediction/lifting/RAHT transform processor may perform the RAHT 40008, LOD generation 40009, and/or lifting transform 40010 of FIG. 4.

The coefficient quantization processor 21009 may quantize the attribute information transformed by the RAHT, the lifting transform, and/or the prediction transform by the prediction/lifting/RAHT transform processor. The coefficient quantization processor may perform the operation of the coefficient quantizer 40011 described with reference to FIG. 4.

The attribute reconstructor 21010 receives the coefficient-quantized attribute information and reconstructs the attribute information. The attribute reconstructor may perform the operation of the attribute reconstructor 19001 described with reference to FIG. 19. The attribute reconstructor may perform the encoding and decoding operations 20001 described with reference to FIG. 20. The coefficient-quantized attribute information may refer to the original point cloud cloud_A described with reference to FIG. 20. The attribute reconstructor may include the attribute reconstruction error compression flag checker 19002 and/or the attribute reconstruction error generator illustrated in FIG. 19. The attribute reconstructor may generate information indicating a correspondence relationship between the reconstructed attribute information and the original attribute information described with reference to FIG. 19.

The attribute reconstructor may generate an attribute reconstruction error by reconstructing attribute information, and determine whether to perform attribute reconstruction error compression based on the attribute reconstruction error. For example, the attribute reconstructor may perform the operation 20003 of comparing the image qualities described with reference to FIG. 20. The attribute reconstructor may generate signaling information (or a flag) indicating whether to perform the attribute reconstruction error compression.

The reconstruction error compressor 21011a compresses the attribute reconstruction error generated by the attribute reconstructor. The reconstruction error compressor may compress the attribute reconstruction error based on the determination of whether to perform the attribute reconstruction error compression by the attribute reconstructor 21010. The reconstruction error compressor may perform the operation of the attribute residual value compressor 19004 described with reference to FIG. 19.

For the reconstructed attribute information, the direct coding unit 21011b may encode the attribute information by directly coding only a value that is not in the range of the attribute information. The direct coding may mean directly encoding information that is included in the reconstructed attribute information, but is not in the range of the original attribute information.

The second arithmetic coder 21012 may entropy-code the attribute information quantized by the coefficient quantization processor. The second arithmetic coder may perform the arithmetic encoding 40012 described with reference to FIG. 4. The second arithmetic coder 21012 may perform the operation of the arithmetic coder 12011 described with reference to FIG. 12.

The elements to perform the attribute reconstruction error compression according to the embodiments (e.g., the attribute reconstructor 21010, the reconstruction error compressor 21011a, and the like of FIG. 21) may all be included in the point cloud data transmission/reception device according to the embodiments. For example, when attribute_error_correction_flag is equal to 1 after the attribute reconstructor 21010 reconstructs the attributes, the point cloud data transmission device may perform the attribute reconstruction error compression or directly coding through the attribute reconstruction error compressor 21011a or the direct coding unit 21011b. According to embodiments, the result of compression or coding by the attribute reconstruction error compressor 21011a or the direct coding unit 21011b is carried in an attribute bitstream, and the attribute encoding process is performed based thereon.

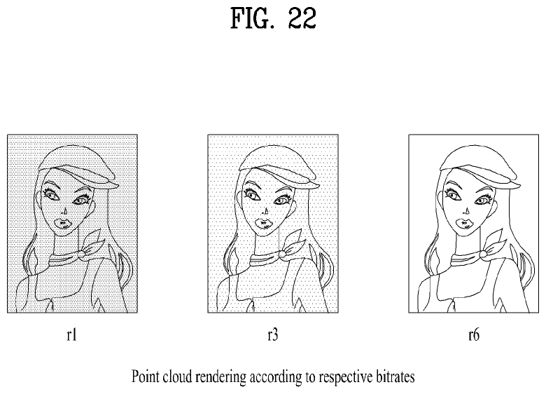

FIG. 22 shows results of rendering of a point cloud according to respective bitrates.

FIG. 22 illustrates results of decoding and rendering of point cloud data received by a decoder of a PCC reception device obtained at respective bitrates according to embodiments. The bitrates allocated for decoding increase from r1 to r6. During the G-PCC attribute loss encoding, the image quality deterioration that occurs in the quantization process may occur.

According to embodiments, the PCC transmission device may perform encoding under various conditions. For example, the PCC transmission device may perform lossy encoding or lossless encoding. Here, the lossy coding may be mainly used in an application that requires low delay or high compression rate to be obtained by processing important attribute information such as color at a low bit-rate. Also, the lossless encoding may be used in an application that requires an original file to be accurately decoded.

In FIG. 22, r1 is a result obtained when the PCC reception device according to the embodiments decodes and renders point cloud data encoded at a low bitrate. In this case, important attribute information may be distorted because encoding is performed at a low bitrate. On the other hand, low-delay transmission/reception or a high compression rate may be ensured.

In FIG. 22, r3 is a result obtained when the PCC reception device according to the embodiments decodes and renders point cloud data encoded at an intermediate bitrate. In the case where encoding is performed at the intermediate bitrate, the PCC transmission/reception device may compromise the presentation of important attribute information and the delay rate or compression rate.

In FIG. 22, r6 is a result obtained when the PCC reception device according to the embodiments decodes and renders point cloud data encoded at a high bitrate. In the case where encoding is performed at a high bitrate, the PCC transmission/reception device may accurately transmit and render important attribute information. Even in this case, an error may occur in attribute information during decoding by the PCC reception device, and thus image quality may be deteriorated.

In the present disclosure, the deterioration of image quality that may occur at any bitrate may be addressed when the PCC transmission device generates, compresses and transmits an attribute reconstruction error, and the PCC reception device receives and reconfigures the information. That is, the structure of the encoder and decoder of the PCC transmission/reception device according to the embodiments may prevent image quality from being deteriorated and allow attribute information to be rendered accurately.

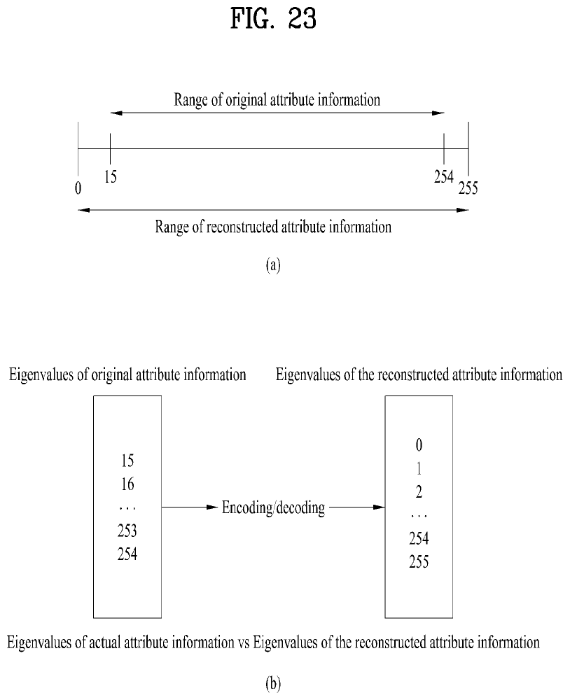

FIG. 23 shows original attribute information and attribute information reconstructed by an attribute reconstruction error compressor according to embodiments.

The attribute reconstruction error compressor according to embodiments may represent the attribute reconstruction error compressor 19000 described with reference to FIG. 19. The attribute reconstruction error compressor may perform, for example, the operations described with reference to FIG. 20. The attribute reconstruction error compressor may include, for example, the attribute reconstructor 21010, the reconstruction error compressor 21011a, and/or the direct coding unit 21011b described with reference to FIG. 21.

In order to compare the degrees of encoding of the position information and the attribute information in the encoding test environment, the current MPEG broadly defines the execution environment according to four conditions. Encoding conditions may be configured using lossy, lossless and near-lossless methods. Lossy compression is a condition in which the point information in the original point cloud before encoding does not need to be necessarily identical to the decoded point information. Lossless compression is a condition in which the point information of the original point cloud should be identical to the decoded point information. Near-lossless coding defines lossless compression that can have errors less than or equal to a specific threshold.

The point cloud may have various actually used bit-ranges of attribute values according to the methods for the data acquisition process. Depending on the characteristics of the double LiDAR, the range of 8 bits (0-254) or 16 bits (0-65535) is used. In this case, the actually observed data may not use all eigenvalues within the range defined by LiDAR. This is an extension of the point cloud video post-processing.

FIG. 23-(A) shows, for example, the range of the attribute values of LiDAR reconstructed by the attribute reconstruction error compressor and the actually observed attribute values.

The encoding/decoding process is performed based on the characteristics of the acquired data. FIG. 23-(B) shows eigenvalues of the original attribute information observed in real data and eigenvalues of reconstructed attribute information.

FIG. 23-(A) shows a range 23000 of the original attribute information of the attribute information and an attribute value range 23001 of points of the point cloud data reconstructed by the attribute reconstruction error compressor (e.g., 19000 in FIG. 19). For example, the range of the reconstructed attribute information may represent the range of the reconstructed attribute information about the LiDAR data. The original attribute information 23000 about the point cloud data according to the embodiments may be different from the range 23001 of the attribute information about the points of the point cloud data reconstructed by the attribute reconstruction error compressor.

The original attribute information belonging to the range 23000 of the original attribute information shown in FIG. 23-(A) may represent the original point cloud cloud_A described with reference to FIG. 20. The range 23001 of the reconstructed attribute information shown in FIG. 23-(A) represents the range of the attribute information about the point cloud cloud_B with deteriorated image quality as described with reference to FIG. 20. The range 23000 of the original attribute information may represent the range of actually observed attribute information (attribute values), and the range 23001 of the reconstructed attribute information may represent the range of the attribute information about the points of the point cloud data reconstructed by the attribute reconstruction error compressor.

The attribute reconstruction error compressor (e.g., 19000 of FIG. 19) according to the embodiments may compare the range 23000 of the original attribute information with the range 23001 of the reconstructed attribute information. For example, there may be a case where the range 23000 of the original attribute information is from 15 to 254, and the range 23001 of the reconstructed attribute information is from 0 to 255. In the reconstructed attribute information, attribute information greater than or equal to 0 or less than 15 is outside the range of the original attribute information. Similarly, attribute information corresponding to 255 is outside the range of the original attribute information. The attribute information less than or equal to 0 or and less than 15 and the attribute information corresponding to 255 may result from an error in the operation of the reconstructor according to the embodiments.

The attribute reconstruction error compressor (e.g., 19000 of FIG. 19) according to the embodiments may generate residual information such that the attribute information about points having attribute information corresponding to 0 or more and less than 15 and attribute information corresponding to 255 in the reconstructed attribute information is mapped into the range of the original attribute information. The reconstruction error compressor according to the embodiments mad establish a correspondence relationship of attribute information based on the range of the original attribute information and the range of the reconstructed property information such that points having attribute information that does not belong to the range of the original attribute information have attribute information within the range of the original attribute information.

In FIG. 23-(A), a point having an attribute value of 2 may have an error corresponding to at least 13 due to the operation of reconstructing attribute information. Accordingly, the attribute reconstruction error compressor (e.g., 19000 in FIG. 19) according to the embodiments may establish a correspondence relationship such that a point having an attribute value corresponding to 2 is mapped to attribute information (e.g., 15) corresponding to the range of the original attribute information. The attribute reconstruction error compressor according to the embodiments may establish a correspondence relationship such that points having values greater than or equal to 0 and less than 15 and a value of 255 are mapped to attribute information corresponding to 15 or 254 (or attribute values within the range of original attribute information).

FIG. 23-(B) illustrates a process of calculating reconstructed attribute information using the operation of encoding and decoding actually observed attribute values. The operation shown in FIG. 23B may be performed by the attribute reconstructor 21010 of FIG. 21 and the attribute reconstructor 19001 of FIG. 19. The operation shown in FIG. 23-(B) may represent the operation shown in FIG. 20.

The eigenvalues of the original attribute information shown in FIG. 23-(B) may represent the values of the attribute information about the original point cloud cloud_A 20000 of FIG. 20. The eigenvalues of the reconstructed attribute information shown in FIG. 23-(B) may represent the values of the attribute information about the original point cloud cloud_A 20000 of FIG. 20.

The eigenvalues of the original attribute information may have attribute values within the range of attribute information corresponding to 15 to 254 as shown in FIG. 23-(A). Points having the attribute values corresponding to 15 to 254 (the eigenvalues of original attribute information) may be encoded/decoded by the attribute reconstruction error compressor (or the attribute reconstructor of the attribute reconstruction error compressor). Here, encoding/decoding may refer to the encoding and decoding operation 20001 described with reference to FIG. 20. When the encoding/decoding is performed, attribute information having eigenvalues of the reconstructed attribute information (the range of the reconstructed attribute information) may be output. Similarly, based on the eigenvalues of the original attribute information and the eigenvalues of the reconstructed attribute information, the attribute reconstruction error compressor according to the embodiments may compare the range of the original attribute information with the range of the reconstructed attribute information, and establish a correspondence relationship of the points, and generate reconstruction errors (e.g., residual information).

The point cloud data encoder according to the embodiments may minimize errors that may occur in the encoding process of the point cloud data due to the configuration of the attribute reconstruction error compressor, and the point cloud data decoder according to the embodiments may minimize the errors generated in the encoding process. For values that cannot be output from the original point cloud data to the decoder, the error rate may be reduced with only small signaling. In addition, the attribute range may be variably clipped according to the characteristics of the data such that the attribute is present only in a specific range. Thereby, the attribute information may be efficiently decoded.

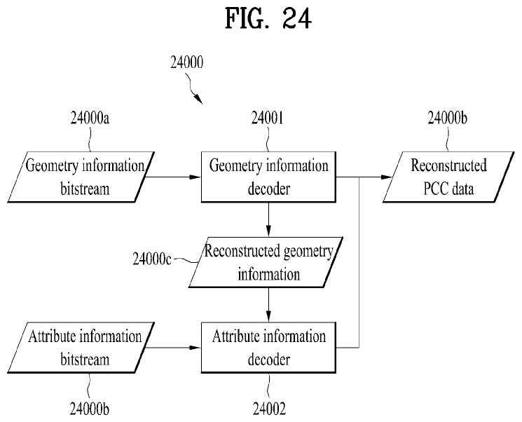

FIG. 24 illustrates a point cloud decoder according to embodiments.

The point cloud decoder 24000 according to the embodiments includes a geometry information decoder 24001 and/or an attribute information decoder 24002. The point cloud decoder 24000 according to embodiments receives a geometry information bitstream 24000a of the point cloud data and/or an attribute information bitstream 24000b of the point cloud data.

The geometry information decoder 24001 and the attribute information decoder 24002 may perform the operations of the point cloud video decoder of FIG. 1, the decoding 20003 of FIG. 2, and the geometry decoder and attribute decoder described with reference to FIG. 10. The geometry information bitstream 24000a and the attribute information bitstream 24000b may be included in the bitstream received by the point cloud data reception device according to the embodiments.

The geometry information decoder 24001 receives and decodes the geometry information bitstream 24000a according to the embodiments. The geometry information decoder 24001 decodes the geometry information bitstream 24000a and outputs geometry information about the reconstructed point cloud data 24000d. The geometry information decoder 24001 may generate reconstructed geometry information 24000c. The geometry information decoder 24001 may perform the operations of the arithmetic decoder 11000, the octree synthesizer 11001, the surface approximation synthesizer 11002, the geometry reconstructor 11003 and/or the coordinate inverse transformer 11004.

The reconstructed geometry information 24000c according to embodiments may represent a geometry reconstructed by the geometry reconstructor (Reconstruct geometry) 11003 described with reference to FIG. 11. The reconstructed geometry information 24000c according to the embodiments may represent an octree occupancy code reconstructed by the occupancy code-based octree reconstruction processor 13003 described with reference to FIG. 13.

The attribution information decoder 24002 receives and decodes the attribution information bitstream 24000b according to the embodiments. The attribute information decoder 24002 decodes the attribute information bitstream 24000b and outputs attribute information about the reconstructed point cloud data 24000d. The attribute information decoder 24002 may generate attribute information about the point cloud data 24000d based on the reconstructed geometry information 24000c according to the embodiments. The attribute information decoder 24001 may perform the operations of the inverse quantizer 11006, the RAHT 11007, the LOD generator 11008, the inverse lifter 11009, and/or the color inverse transformer 11010 of FIG. 11.

The point cloud data decoder 24000 according to embodiments may receive and decode the attribute information bitstream. The point cloud data decoder according to embodiments may generate attribute information by predicting attribute information in the process of decoding the attribute information. However, when the attribute information encoder 24002 according to embodiments predicts attribute information about a specific point, an error may occur with respect to the attribute information about the original point cloud data. Accordingly, the attribution information decoder 24002 according to the embodiments may extract residual information from the attribution information bitstream 24000b in order to cancel the error. Accordingly, the attribution information decoder 24002 according to the embodiments may include a residual information processor to extract residual information from the attribution information bitstream 24000b and add/subtract the residual information to/from the attribute information predicted by a prediction method according to the embodiments.

The attribute information decoder 24002 according to the embodiments may include the arithmetic decoding unit 11005, the inverse quantizer 11006, the RAHT inverse transformer 11007, the LOD generator 11008, and the inverse lifter 11009, and/or the color inverse transformer 11010 of FIG. 11. However, when the attribute information about the point cloud data is encoded according to FIG. 11 or 13, the image quality of some point cloud data may be deteriorated. This is because, in the process of decoding the attribute information about the point cloud data according to the embodiments, attribute information about some points may be lost.

For example, the point cloud data reception device according to the embodiments predicts attribute information about specific points by prediction or lifting, and transmits or renders the predicted attribute information. In this case, the prediction of the attribute information is generated based on the distance of the points and the attribute information thereon for efficiency of transmission and reception of point cloud data, and there is no process of correcting the attribute information after the attribute information is predicted.

Such prediction is based on the assumption that the values of the attribute information are similar as the distance between the points is closer. Accordingly, if the attribute information about the point cloud data is irregularly distributed or the data has a large difference in attribute value among the points at a close distance, the image quality may be greatly deteriorated. Accordingly, the point cloud data transmission device (or the attribute information encoder 18002) according to the embodiments may compress and transmit an error (e.g., residual information) generated in reconstructing the attribute information according to the embodiments as in the embodiments illustrated in FIGS. 18 to 22.

Accordingly, the attribute information decoder 24002 of the point cloud data reception device 24000 according to the embodiments may receive the attribute information bitstream 24000b including the error (e.g., residual information) included in the bitstream transmitted from the point cloud data transmission device. The attribute information decoder 24002 may further include a residual information processor to receive the attribute information bitstream 24000b including the error and processes the same.

A method of receiving point cloud data according to embodiments may include receiving a bitstream containing point cloud data and signaling information, decoding the point cloud data, and/or rendering the point cloud data.

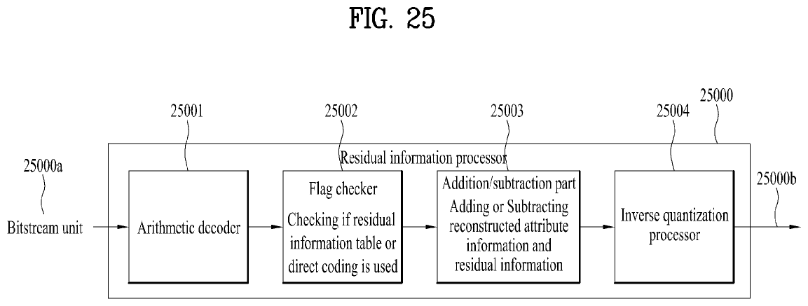

FIG. 25 illustrates a residual information processor according to embodiments.

A residual information processor 25000 according to the embodiments may receive a bitstream unit 25000a according to the embodiments and output inversely quantized attribute information 25000b. The residual information processor 25000 may include an arithmetic decoder 25001, a flag checker 25002, an addition/subtraction part 25003, and/or an inverse quantization processor 25004.

The bitstream unit 25000a according to the embodiments may represent a unit of an attribute information bitstream containing attribute information about point cloud data according to embodiments. The bitstream unit 25000a according to the embodiments may represent, for example, the attribute information bitstream 24000b of FIG. 24. The bitstream unit 25000a according to the embodiments may be a bitstream in a slice unit or a bitstream in a tile unit.

The bitstream unit 25000a refers to an performance unit of an operation performed by the residual processor according to the embodiments. The bitstream unit may be determined by the reception processor 13001 or the receiver 13000 described with reference to FIG. 13. The bitstream unit may refer to a unit of a bitstream in which a block described and illustrated in FIG. 6 or a bundle of one or more blocks is encoded (attribute information encoding) and output according to embodiments.

The bitstream unit 25000a may include attribute information and residual information about points of the point cloud data according to the embodiments. The residual information may include the attribute reconstruction error described with reference to FIGS. 19 to 23. The residual information may include information for cancelling an error between the predicted attribute information and the original point cloud data after the point cloud data decoder according to the embodiments performs prediction on the attribute information about a specific point.

The arithmetic decoder 25001 receives the bitstream unit 25000a according to the embodiments, and performs arithmetic decoding on the bitstream unit 25000a. The arithmetic decoder 25001 may perform, for example, the operation of the arithmetic decoding 11005 described with reference to FIG. 11 and the operation of the arithmetic decoder 13007 of FIG. 13.

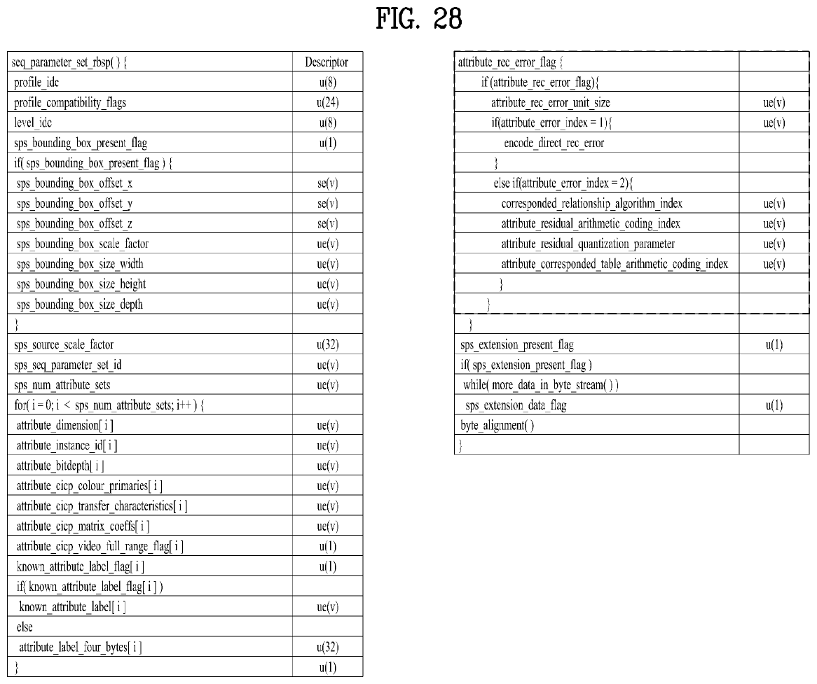

Here, the arithmetic decoder may perform arithmetic decoding based on arithmetic decoding related signaling information contained in the bitstream received by the PCC reception device (or the bitstream unit received by the residual value processor). The arithmetic decoding related signaling information may be, for example, attribute_corresponded_table_arithmetic_coding_index included in FIGS. 28 to 31.

The arithmetic decoder 25001 may decode attribute information and residual information about points of the point cloud data included in the bitstream unit 25000a according to embodiments. The arithmetic decoder 25001 according to the embodiments may output attribute information about the points of the decoded point cloud data, that is, attribute information about the points. The arithmetic decoder 25001 may extract residual information by decoding a bitstream containing the residual information according to the embodiments. The residual information extracted by the arithmetic decoder 25001 may include attribute reconstruction error information about specific points and/or information related to residual information processing.

The flag checker 25002 may parse the residual information extracted by the arithmetic decoder 25001. The flag checker 25002 may determine whether the residual information processor 25000 according to the embodiments is to cancel (or add or subtract) the attribute reconstruction error for specific points based on the residual information. The flag checker 25002 may determine how to cancel (or add or subtract) the attribute reconstruction error for specific points based on the residual information.

The information related to the residual information processing may include information (or flag) indicating whether to cancel the attribute reconstruction error for specific points, and information (or flag) indicating a method to cancel (or add or subtract) the attribute reconstruction error. For example, the information related to the residual information processing may include information (or flag) indicating whether a residual information table is present in the received bitstream unit 25000a, and information (or a flag) indicating whether to cancel the attribute reconstruction error according to direct coding of the attribute information according to the embodiments.

The information related to the residual information processing may include information (flag) indicating whether to perform the attribute reconstruction error compression described with reference to FIG. 21. The flag checker may check the information (or flag) indicating whether to perform the attribute reconstruction error compression, and check whether the received bitstream unit 25000a indicates the original attribute information to be decoded or includes residual information (and/or reconstructed attribute information) for the original attribute information. The information (or flag) indicating whether to perform the attribute reconstruction error compression may include attribute_corresponded_table_arithmetic_coding_index and/or corresponded_relationship_algorithm_index included in FIGS. 28 to 31.

For example, when the information indicating whether to perform the attribute reconstruction error compression indicates that the received bitstream unit is the original attribute information, coding may be performed directly on the bitstream unit. When the information indicating whether to perform the reconstruction error compression indicates that the received bitstream unit includes residual information, the operation of the addition/subtraction part extracting original attribute information may be performed by adding or subtracting the reconstructed attribute information and the residual information for the bitstream unit.

That is, when the information indicating whether to perform the attribute reconstruction error compression indicates that the received bitstream unit is the original attribute information, the received bitstream unit includes quantized original attribute information. When the information indicating whether to perform the attribute reconstruction error compression indicates that the received bitstream unit includes residual information, the received bitstream unit may include the reconstructed attribute information and residual information (and/or residual information table).

Here, the direct coding may mean modifying the attribute information about a point to be additionally corrected to the actual attribute information about the point when the point is present in the point cloud data. Here, the residual information table may be a table including points to be additionally subtracted or added (or corrected) in the point cloud data and a degree of additional subtraction or addition (or correction). For example, when the attribute information about a specific point A needs to be corrected by subtracting 3 therefrom after decoding, the residual information table according to the embodiments may provide position information about the specific point A (or information for identifying the specific point) and the amount of subtraction (or correction amount, for example, −3) for the specific point (A).

When the information (flag) indicating whether to perform attribute reconstruction error compression indicates that the received bitstream unit contains residual information, the addition/subtraction part 25003 may extract attribute information about each of the points by adding/subtracting the residual information to/from the reconstructed attribute information contained in the received bitstream unit.

The inverse quantization processor 25004 may inverse quantize the original attribute information extracted by the direct coding and/or the attribute information corrected (extracted) by the addition/subtraction part. Here, inverse quantization may be performed based on inverse quantization-related signaling information contained in the bitstream received by the point cloud data reception device (or the bitstream unit received by the residual value processor). The inverse quantization-related signaling information may include information indicating how the inverse quantization processor performs inverse quantization. The arithmetic decoding related signaling information may be, for example, attribute_residual_quantization_parameter included in FIGS. 28 to 31.

The point cloud data reception device according to the embodiments may arithmetically decode the bitstream unit transmitted from the transmission device. The point cloud data reception device according to the embodiments checks whether residual information, generation of a residual information table, and/or direct coding for the arithmetically decoded bitstream. The point cloud data reception device according to the embodiments may correct the attribute information by adding/subtracting the attribute information (e.g., predicted attribute information) and the attribute reconstruction error information of the residual information based on the residual information (e.g., attribute reconstruction error compression flag) transmitted from the transmission device.

According to embodiments, the attribute reconstruction value may conform to run length encoding or entropy encoding of the arithmetic encoding used at the transmitting side, and attribute_residual_arithmetic_coding_index, attribute_residual_quantization_parameter, attribute_corresponded_table_arithmetic_coding_index, and the like delivered from the transmitting side may be received. The attribute value reconstructor according to the embodiments may reconstruct the attribute information based on the above-described parameters.

According to embodiments, decoding the point cloud data may include: reconstructing geometry information from a geometry bitstream of a bitstream; decoding an attribute bitstream of the bitstream; based on the reconstructed geometry information, inversely transforming attribute information about points; and reconstructing attribute information about the inversely transformed points based on the residual information. Here, the decoding may generate attribute information and residual information about the points of the point cloud data.

According to embodiments, the signaling information may include first information indicating whether to reconstruct attribute information. In the operation of reconstructing the attribute information about the inversely transformed points, reconstructed attribute information may be generated by adding/subtracting the residual information to/from the attribute information about the inversely transformed points according to the first information.

According to embodiments, the signaling information may further include second information related to a correspondence relationship between the residual information and the attribute information about the inversely transformed points and third information related to a compression method for the residual information. The reconstructing of the attribute information about the inversely transformed points may include adding/subtracting the residual information to/from the attribute information about the inversely transformed points based on the second information. In addition, the reconstructing of the attribute information about the inversely transformed points may also include decoding the added or subtracted attribute information based on the third information.

For values that cannot be output from the original point cloud data to the decoder, the error rate may be reduced with only small signaling. In addition, the attribute range may be variably clipped according to the characteristics of the data such that the attribute is present only in a specific range. Thereby, the attribute information may be efficiently decoded.

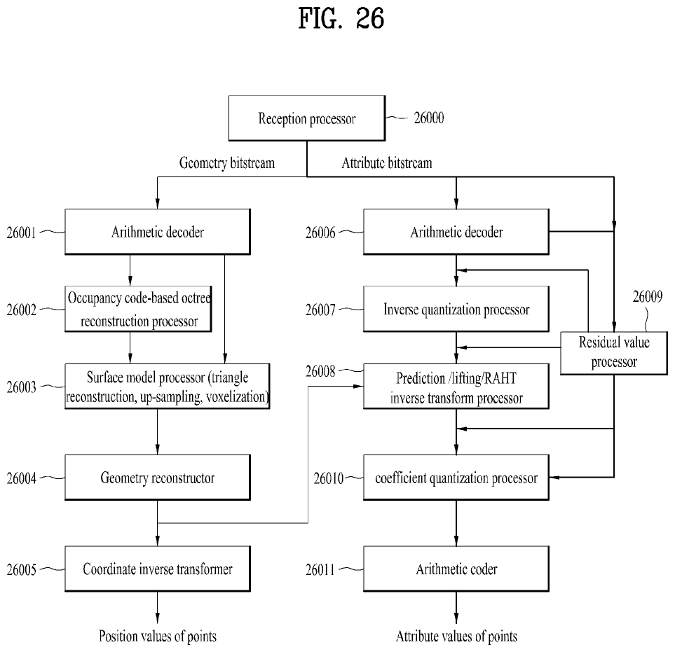

FIG. 26 illustrates a decoder of a point cloud data reception device according to embodiments.

The decoder of the point cloud data reception device according to the embodiments may include a reception processor 26000, a first arithmetic decoder 26001, an occupancy code-based octree reconstruction processor 26002, a surface model processor 26003, a geometry reconstructor 26004, a coordinate inverse transformer 26005, a second arithmetic decoder 26006, an inverse quantization processor 26007, a prediction/lifting/RAHT inverse transform processor 26008, a residual value processor 26009, an attribute reconstructor 26010, and/or a color inverse transform processor 26011.

The reception processor 26000 may receive a bitstream containing point cloud data and/or signaling information according to embodiments. The reception processor may parse the received bitstream to output a geometry bitstream, an attribute bitstream, and/or signaling information (flags).

The first arithmetic decoder 26001 may receive the geometry bitstream and perform arithmetic decoding on the geometry bitstream.

The occupancy code-based octree reconstruction processor 26002 may receive the geometry bitstream decoded by the first arithmetic decoder and reconstruct an occupancy code-based octree.

The surface model processor 26003 may receive the geometry bitstream decoded by the first arithmetic decoder and perform surface model processing on the corresponding data. For example, the surface model processor may perform a triangle reconstruction operation, an up-sampling operation, and/or a voxelization operation.

The geometry reconstructor 26004 may receive the data (i.e., geometry data) processed by the surface model processor and reconstruct the same.

The coordinate inverse transformer 26005 may inversely transform the points of the geometry data reconstructed by the geometry reconstructor.

The second arithmetic decoder 26006 may arithmetically decode the attribute bitstream received from the reception processor.

The inverse quantization processor 26007 may receive the bitstream decoded by the second arithmetic decoder and inverse quantize the same. The inverse quantization processor may perform the same or similar operation to that of the inverse quantization processor 25004 described with reference to FIG. 25.

The prediction/lifting/RAHT inverse transform processor 26008 may inversely transform the inverse quantized attribute information. The inverse transform may be an inverse transform using prediction, an inverse transform using lifting, and/or an inverse transform using RATH.

The residual value processor 26009 may receive the attribute bitstream decoded by the second arithmetic decoder. The residual value processor may perform operations included in the residual value processor described with reference to FIG. 25. That is, the received attribute bitstream may include the bitstream unit 25000 described with reference to FIG. 25.

The residual value processor 26009 may receive the attribute bitstream of the bitstream received by the reception processor 26000. The residual value processor 26009 may receive the attribute bitstream and perform the operations of the arithmetic decoder 25001, the flag checker 25002, the addition/subtraction part 25003 and/or the inverse quantization processor 25004. The attribute bitstream on which all or part of the operation of the residual information processor 25000 has been performed may be transmitted to the inverse quantization processor 26007, the prediction/lifting/RAHT inverse transform processor 26008 and/or the attribute reconstructor 26010.

The attribute reconstructor 26010 may reconstruct attribute information based on the residual value processed by the residual value processor 26009 according to the embodiments. The attribute reconstructor 26010 according to the embodiments may perform the operation of the addition/subtraction part 25003 of FIG. 25. The attribute reconstructor 26010 may generate attribute information to be reconstructed based on the residual information extracted by the residual value processor 26009 and the attribute information extracted by the prediction/lifting/RAHT inverse transform processor.

The color inverse transform processor 26011 may receive the reconstructed or inverse quantized attribute information from the attribute reconstructor 26010 or the inverse quantization processor 26007 and inversely transform the same into colors.

In the point cloud data reception device according to embodiments, when attribute_error_correction_flag is 1 (i.e., on), the attribute reconstructor 26010 may be executed. The attribute decoding process may be performed based on the reconstructed result (see FIGS. 10 and 11 and related description of the decoding process)

A method of receiving point cloud data according to embodiments may include receiving a bitstream containing point cloud data and signaling information, decoding the point cloud data, and/or rendering the point cloud data.

The decoding of the point cloud data according to the embodiments may include reconstructing geometry information from a geometry bitstream of a bitstream; decoding an attribute bitstream of the bitstream; based on the reconstructed geometry information, inversely transforming attribute information about points, and/or reconstructing the inversely transformed attribute information about the points based on the residual information. The decoding may include generating attribute information and residual information about points of the point cloud data.

The signaling information according to the embodiments may include first information indicating whether to reconstruct attribute information. According to embodiments, the reconstructing of the inversely transformed attribute information about the points may include generating reconstructed attribute information by adding/subtracting the residual information to/from the inversely transformed attribute information about the points according to the first information.

The signaling information according to the embodiments may further include second information related to a correspondence relationship between the residual information and the inversely transformed attribute information about the points and third information related to a compression method for the residual information. According to embodiments, the reconstructing of the inversely transformed attribute information about the points may include adding/subtracting the residual information to/from the inversely transformed attribute information about the points based on the second information. The reconstructing of the inversely transformed attribute information about the points may include decoding the added or subtracted attribute information based on the third information.

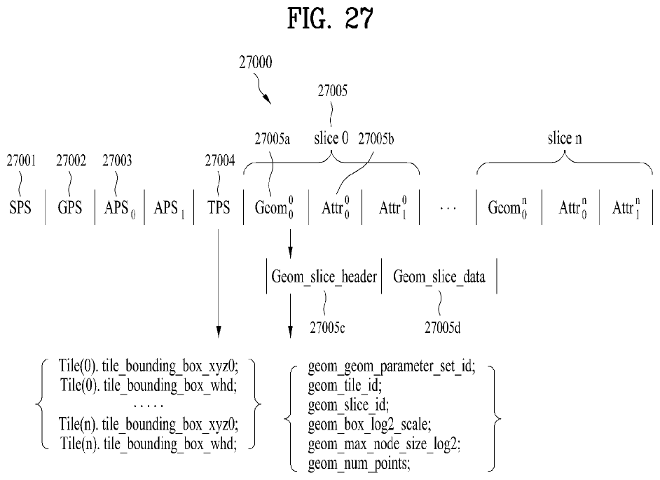

FIG. 27 shows an exemplary structure of point cloud data according to embodiments.

Point cloud data according to embodiments may be generated by the point cloud video acquirer 10001 of FIG. 1, the acquisition 20000 of FIG. 2, and the method described with reference to FIG. 3. The point cloud data according to the embodiments may be encoded by the spatial partitioner 18000, the geometry information encoder 18001, and/or the attribute information encoder 18002 of FIG. 18. The point cloud data according to the embodiments may be encoded by the operations shown in FIGS. 19 to 23. The point cloud data according to the embodiments may be encoded as described above to generate a bitstream of the point cloud data according to embodiments. The bitstream of the point cloud data according to the embodiments may be transmitted by the transmitter 10003 of FIG. 1 or the transmitter 20002 of FIG. 2.

The bitstream of the point cloud data according to the embodiments may be received by the receiver of the point cloud data reception device according to the embodiments. For example, the bitstream of the point cloud data according to the embodiments may be received by the receiver 10005 of FIG. 1, the receiver 20002 of FIG. 2, or the receiver 13000 of FIG. 13. The bitstream of the point cloud data according to the embodiments may be decoded and output by the methods and elements shown in FIGS. 24 to 26 (e.g., the geometry information decoder 24001 of FIG. 24, the attribute information decoder 24002 of FIG. 24, the residual information processor 25000 of FIG. 25 and the components 26001 to 26011 of FIG. 26).

An point cloud data transmission device according to embodiments may transmit a bitstream 27000 having a bitstream structure as shown in FIG. 27. The bitstream 27000 of the point cloud data may include a sequential parameter set (SPS) 27001, a geometry parameter set (GPS) 27002, an attribute parameter set (APS) 27003, a tile parameter set (TPS) 27004, and one or more slices 27005. The bitstream 27000 of the point cloud data may include one or more tiles. According to embodiments, a tile may be a slice group including one or more slices.

The SPS 27001 is a syntax structure containing syntax elements that apply to zero or more entire CVSs as determined by the content of a syntax element found in the PPS referred to by a syntax element found in each slice segment header. The SPS may include sequence information about the point cloud data bitstream according to embodiments.

The GPS 27002 may represent a syntax structure containing syntax elements to which zero or more entire geometries (or coded geometries) are applied. The GPS 27002 according to the embodiments may include information about a method of encoding attribute information about point cloud data included in the one or more slices 27005. The GPS 27002 may include SPS identifier information indicating SPS 27001 to which contained geometry parameters are related according to embodiments, and GPS identifier information for identifying the GPS.

The APS 27003 may represent a syntax structure containing syntax elements to which zero or more all attributes (or coded attributes) are applied. The APS 27003 according to the embodiments may include information about a method of encoding attribute information about point cloud data included in the one or more slices 27005. The APS 27003 may include SPS identifier information indicating the SPS 27001 to which the contained geometry parameter is related according to embodiments, and APS identifier information for identifying the APS.

The TPS 27004 may represent a syntax structure containing syntax elements to which zero or more entire tiles (or coded tiles) are applied. The TPS includes information about zero or more tiles included in the point cloud data bitstream according to embodiments. The TPS may be referred to as a tile inventory according to embodiments.

The tile inventory 27004 may include identifier information for identifying one or more tiles and information indicating a range of the one or more tiles (i.e., a bounding box of the tile). The information indicating the range of the one or more tiles (i.e., the bounding box of the tile) may include coordinate information (e.g., Tile(n).tile_bounding_box_xyz0) about a point serving as a reference of the bounding box indicated by the tile and information (e.g., Tile(n).tile_boudning_box_whd) about the width, height, and depth of the bounding box. When a plurality of tiles is present, the tile inventory 27004 may include information indicating a bounding box for each of the tiles. For example, when the tiles are represented as 0 to n by the identifier information about the tiles, the information indicating the bounding boxes of the tiles may be represented as Tile(0).tile_bounding_box_xyz0, Tile(0).tile_bounding_box_whd, Tile(1).tile_bounding_box_xyz0, Tile(1).tile_bounding_box_whd, and the like

The slice 27005 may represent a unit forming the basis of encoding of the point cloud data by a point cloud data transmission device according to embodiments. According to embodiments, the slice 27005 may represent a unit including one geometry bitstream Geom00 and one or more attribute bitstreams Attr00 and Attr10.

The slice 27005 may include a geometry slice (Geom) 27005a indicating the geometry information about the point cloud data included in the slice, and one or more attribute slices (Attr) 27005b indicating the attribute information about the point cloud data included in the slice.

The geometry slice (Geom) 27005a includes geometry slice data (Geom_slice_data) 27005d including geometry information about the point cloud data, and a geometry slice header (Geom_slice_header (GSH)) 27005c including information about the geometry slice data.

The geometry slice header 27005c includes information about the geometry slice data 27005d in the slice. For example, the geometry slice header 27005c may include a geometry parameter set identifier (geom_geom_parameter_set_id) for identifying the GPS 27002 that indicates the geometry information about the slice, a geometry slice identifier (geom_slice_id) for identifying the geometry slice, geometry box origin information (geomBoxOrigin) indicating the box origin of the geometry slice data, information (geom_box_log 2_scale) indicating the log scale of the geometry slice, and information (geom_num_points) related to the number of points of the geometry slice.

When the point cloud data bitstream according to the embodiments includes one or more tiles, the header of the geometry bitstream according to the embodiments may further include information (geom_tile_id) for identifying a tile including the geometry bitstream.

The attribute slice (Attr) 27005a includes attribute slice data (Attr_slice_data) including attribute information about point cloud data, and attribute slice header (Attr_slice_header (ASH) 27005c including information about the attribute slice data.

According to embodiments, parameters necessary for point cloud encoding may be newly defined as a parameter set and header information for the point cloud. For example, they may be added to the attribute parameter set RB SP syntax in performing attribute information encoding, and may be added to the tile_header syntax in performing tile-based encoding.

According to embodiments, the above-described parameters according to the embodiments shown in FIG. 27 may be signaled on a tile-by-tile basis or slice-by-slice basis, which will be described later. The above-described parameters according to the embodiments may be signaled within the sequential parameter set (SPS), the geometry parameter set (GPS), the attribute parameter set (APS), or the tile inventory.

For example, when the point cloud data according to the embodiments is transmitted on a slice-by-slice basis, the parameters shown in FIG. 27 according to the embodiments may be included in the APS including information on attribute information about each slice.

As another example, when the point cloud data according to the embodiments is transmitted on a slice-by-slice basis, the parameters shown in FIG. 27 according to the embodiments may be included in a geometry slice header (gsh).

For example, when the point cloud data according to the embodiments is transmitted on a tile-by-tile basis, the parameters shown in FIG. 27 according to the embodiments may be included in the TPS(tile parameter set) including information on attribute information about each tile (or tile inventory).

The SA-DCT function according to embodiments may receive point cloud data from a bitstream. According to embodiments, the information may be R, G, B, reflectance, and the like when the corresponding method is applied in encoding attribute information, and may be coordinate information such as x, y, or z when geometry information is encoded.

As the PCC transmission/reception method according to the embodiments may provide the bitstream structure as described above, the decoding performance of the receiver for the attribute information about the point cloud data may be enhanced. In addition, more robust quantization may be implemented by signaling the SA-DCT transform, and accordingly a perceptual improvement in inverse transform performance may be provided at the output terminal of the decoder.

FIG. 28 shows a sequence parameter set (SPS) of a bitstream transmitted by a point cloud data transmission device (or a bitstream received by a point cloud data reception device) according to embodiments.

All or part of the signaling information and/or flags described with reference to FIGS. 18 to 27 may be included in the SPS described and illustrated in FIG. 28.

attribute_rec_error_flag is signaling information indicating whether to perform attribute information error reconstruction according to embodiments. attribute_rec_error_flag may be a flag.

attribute_rec_error_unit_size indicates the size of an attribute information unit for indicating a unit of residual information (residual value) for the attribute information according to embodiments.

attribute_error_index indicates a compression method by which the residual attribute information (or attribute information) is compressed according to embodiments. For example, 1 may indicate direct coding, 2 may indicate error table configuration (nearest-neighbor search algorithm), 3 may indicate error table configuration (mean square error (MSE)).

attribute_error_index equal to 1 indicates that the attribute information is compressed by direct coding. In the direct coding according to the embodiments, only loss information is added to a bitstream by sequentially transferring values for points mapped thereto in one-to-one correspondence.

attribute_error_index equal to 2 indicates that the attribute information is compressed by the method of configuring an error table. In this case, due to the parameter, it may be seen that the PCC transmission device according to the embodiments transmits the residual information (residual value) by configuring a table with a correspondence relationship establishment algorithm such as the least error point search using various nearest-neighbor search algorithms.

attribute_error_index equal to 3 indicates that the attribute information is compressed by the method of configuring an error table. In this case, it may be seen that the residual information (residual value) has been transferred by configuring a table with a correspondence relationship establishment algorithm such as the minimum error point search using the mean square error (MSE). That is, in embodiments, the error table may include a difference between an attribute value of an input attribute and predicted attribute information (e.g., a mean square error distance between the two attributes).

encode_direct_rec_error indicates information that directly carries a residual value without quantizing the value or composing a correspondence table. encode_direct_rec_error indicates that encoding has been performed by direct coding rather than a residual information table indicating an attribute reconstruction error and a target point of the error. For example, encode_direct_rec_error equal to 1 for a specific point indicates that the point cloud data transmission device according to the embodiments has transmitted actual attribute information about the point, not the attribute reconstruction error for the point. Therefore, encode_direct_rec_error equal to 1 indicates that the point is subjected to direct coding.

corresponded_relationship_algorithm_index indicates information indicating an algorithm used to transmit information on the algorithm for establishing a correspondence relationship between the reconstruction value selected by the attribute reconstruction error compressor and the original value. That is, it indicates an algorithm for establishing a correspondence relationship according to embodiments.

attribute_residual_arithmetic_coding_index indicates information on an arithmetic coding method used instead of the arithmetic coding method used by the existing encoder.

attribute_residual_quantization_parameter indicates information on a quantization coefficient in compressing residual attribute information according to embodiments.

attribute_corresponded_table_arithmetic_coding_index indicates information on an arithmetic coding method used by the encoder when various arithmetic coding methods may be used for the attribute value correspondence table.

profile_idc may be information indicating a profile to which the bitstream conforms as specified in Annex A of standard document H.264. Bitstreams shall not contain values of profile_idc other than those specified in Annex A. Other values of profile_idc may be reserved for future use by ISO/IEC.

profile_compatibility_flags equal to 1 may indicate that the bitstream conforms to the profile indicated by profile_idc equal to j as specified in Annex A. The value of profile_compatibility_flag[j] shall be equal to 0 for any value of j that is not specified as an allowed value of profile_idc in Annex A.

level_idc indicates a level to which the bitstream conforms as specified in Annex A of standard document H.264. Bitstreams may not contain values of level_idc other than those specified in Annex A. Other values of level_idc may be reserved for future use by ISO/IEC.

sps_bounding_box_present_flag equal to 1 may specify that the bounding box offset and size information is signaled.

sps_bounding_box_offset_x indicates the x offset of the source bounding box in the Cartesian coordinates. When not present, the value of sps_bounding_box_offset_x may be inferred to be 0.

sps_bounding_box_offset_y indicates the y offset of the source bounding box in the Cartesian coordinates. When not present, the value of sps_bounding_box_offset_y may be inferred to be 0.

sps_bounding_box_offset_z indicates the z offset of the source bounding box in the Cartesian coordinates. When not present, the value of sps_bounding_box_offset_z may be inferred to be 0.

sps_bounding_box_scale_factor indicates the scale factor of the source bounding box in the Cartesian coordinates. When not present, the value of sps_bounding_box_scale_factor may be inferred to be 1. When not present, the value of sps_bounding_box_scale_factor may be inferred to be 0.

sps_bounding_box_size_width indicates the width of the source bounding box in the Cartesian coordinates. When not present, the value of sps_bounding_box_size_width may be inferred to be a specific value (such as 10).

sps_bounding_box_size_height indicates the height of the source bounding box in the Cartesian coordinates. When not present, the value of sps_bounding_box_size_height may be inferred to be 1. When not present, the value of sps_bounding_box_size_hieght may be inferred to be 0.

sps_bounding_box_size_depth indicates the depth of the source bounding box in the Cartesian coordinates. When not present, the value of sps_bounding_box_size_depth may be inferred to be 1. When not present, the value of sps_bounding_box_size_depth may be inferred to be 0.

sps_source_scale_factor indicates the scale factor of the source point cloud.

sps_seq_parameter_set_id provides an identifier for the SPS for reference by other syntax elements. The value of sps_seq_parameter_set_id may be in the range of 0 to 15, inclusive in bitstreams conforming to this version of this Specification. The value other than 0 for sps_seq_parameter_set_id may be reserved for future use by ISO/IEC.

sps_num_attribute_sets indicates the number of coded attributes in the bitstream. The value of sps_num_attribute_sets may be in the range of 0 to 64.

attribute_dimension[i] specifies the number of components of the i-th attribute.

attribute_instance_id[i] specifies attribute instance id.)

attribute_bitdepth[i] specifies the bitdepth of the i-th attribute signal(s).

attribute_cicp_colour_primaries[i] indicates the chromaticity coordinates of the color attribute source primaries.

attribute_cicp_transfer_characteristics[i] may either indicate the reference opto-electronic transfer characteristic function of the color attribute as a function of a source input linear optical intensity Lc with a nominal real-valued range of 0 to 1 or indicate the inverse of the reference electro-optical transfer characteristic function as a function of an output linear optical intensity Lo with a nominal real-valued range of 0 to 1.

attribute_cicp_matrix_coeffs[i] describes the matrix coefficients used in deriving luma and chroma signals from the green, blue, and red, or Y, Z, and X primaries.

attribute_cicp_video_full_range_flag[i] specifies the black level and range of the luma and chroma signals as derived from E′Y, E′PB, and E′PR or E′R, E′G, and E′B real-valued component signals.

known_attribute_label_flag[i] equal to 1 specifies that know_attribute_label is signaled for the i-th attribute. known_attribute_label_flag[i] equal to 0 specifies that attribute_label_four_bytes is signaled for the i-th attribute.

known_attribute_label[i] equal to 0 specifies that the attribute is color. known_attribute_label[i] equal to 1 specifies that the attribute is reflectance. known_attribute_label[i] equal to 2 specifies that the attribute is frame index.

attribute_label_four_bytes[i] specifies . . . .

sps_extension_present_flag equal to 1 specifies that the sps_extension_data syntax structure is present in the SPS RBSP syntax structure. sps_extension_present_flag equal to 0 specifies that this syntax structure is not present. When not present, the value of sps_extension_present_flag may be inferred to be equal to 0.

sps_extension_data_flag may have any value. Its presence and value do not affect decoder conformance to profiles specified in Annex A of the standard document. Decoders conforming to a profile specified in Annex A.

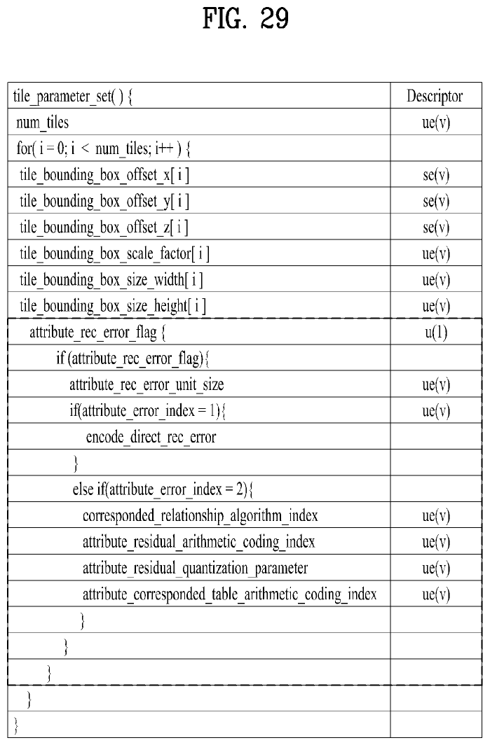

FIG. 29 shows a tile parameter set (TPS) of a bitstream transmitted by a point cloud data transmission device (or a bitstream received by a point cloud data reception device) according to embodiments.

According to embodiments, corresponded_relationship_algorithm_index, attribute_residual_arithmetic_coding_index, attribute_residual_quantization_parameter, and attribute_corresponded_table_arithmetic_coding_index may represent the parameters described with reference to FIG. 28.

num_tiles represents the number of tiles signaled for the bitstream. When there is no tile present in the bitstream, num_tiles may be inferred to be 0.

tile_bounding_box_offset_x[i] indicates the x offset of the i-th tile in the Cartesian coordinates. When the x offset is not present, the value of tile_bounding_box_offset_x[0] may be inferred to be sps_bounding_box_offset_x.

tile_bounding_box_offset_y[i] indicates the y offset of the i-th tile in the Cartesian coordinates. When the y offset is not present, the value of tile_bounding_box_offset_y[0] may be inferred to be sps_bounding_box_offset_y.

tile_bounding_box_offset_z[i] indicates the z offset of the i-th tile in the Cartesian coordinates. When the z offset is not present, the value of tile_bounding_box_offset_z[0] may be inferred to be sps_bounding_box_offset_z.

tile_bounding_box_scale_factor[i] indicates the scale factor related to the i-th tile in the Cartesian coordinates. When not present, the value of tile_bounding_box_scale_factor[0] may be inferred to be sps_bounding_box_scale_factor.

tile_bounding_box_size_width[i] indicates the width of the i-th tile in the Cartesian coordinates. When not present, the value of tile_bounding_box_size_width[0] may be inferred to be sps_bounding_box_size_width.

tile_bounding_box_size_height[i] indicates the height of the i-th tile in the Cartesian coordinates. When not present, the value of tile_bounding_box_size_height[0] may be inferred to be sps_bounding_box_size_height.

tile_bounding_box_size_depth[i] indicates the depth of the i-th tile in the Cartesian coordinates. When not present, the value of tile_bounding_box_size_depth[0] may be inferred to be sps_bounding_box_size_depth.

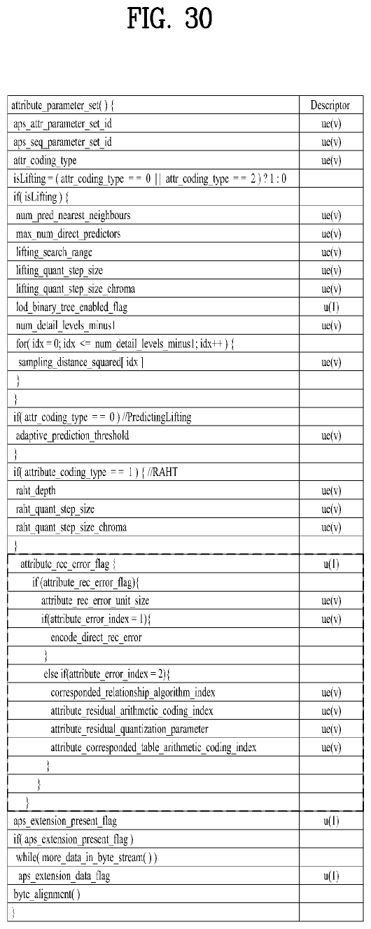

FIG. 30 shows an attribute parameter set (APS) of a bitstream transmitted by a point cloud data transmission device (or a bitstream received by a point cloud data reception device) according to embodiments.

According to embodiments, corresponded_relationship_algorithm_index, attribute_residual_arithmetic_coding_index, attribute_residual_quantization_parameter, and attribute_corresponded_table_arithmetic_coding_index may represent the parameters described with reference to FIG. 28.

aps_attr_parameter_set_id may represent an identifier for the APS for reference by other syntax elements. The value of aps_attr_parameter_set_id may be in the range of 0 to 15, inclusive.

aps_seq_parameter_set_id may specify the value of sps_seq_parameter_set_id for the active SPS. The value of aps_seq_parameter_set_id shall be in the range of 0 to 15, inclusive.

attr_coding_type may indicate the coding type for the attribute for the given value of attr_coding_type. The value of attr_coding_type may be equal to 0, 1, or 2 in bitstreams conforming to this version of this Specification. Other values of attr_coding_type may be reserved for future use by ISO/IEC. Decoders conforming to this version of this Specification may ignore reserved values of attr_coding_type: 0=Predicting weight lifting; 1=Region Adaptive Hierarchical Transform (RAHT); 2=Fixed weight lifting.

num_pred_nearest_neighbours may specify the maximum number of nearest neighbors to be used for prediction. The value of numberOfNearestNeighboursInPrediction may be in the range of 1 to xx.

max_num_direct_predictors may specify the maximum number of predictors to be used for direct prediction. The value of max_num_direct_predictors may be in the range of 0 to num_pred_nearest_neighbours. The value of the variable MaxNumPredictors that is used in the decoding process may be specified as follows:

MaxNumPredictors=max_num_direct_predicots+1

lifting_search_range may specify a search range for the lifting.

lifting_quant_step_size may specify the quantization step size for the first component of the attribute. The value of quant_step_size may be in the range of 1 to xx.

lifting_quant_step_size_chroma may specify the quantization step size for the chroma component of the attribute when the attribute is color. The value of quant_step_size_chroma may be in the range of 1 to xx.

lod_binary_tree_enabled_flag may specify whether binary tree is enabled or not for the log generation.

num_detail_levels_minus1 specifies the number of levels of detail for the attribute coding. The value of num_detail_levels_minus1 may be in the range of 0 to xx.

sampling_distance_squared[idx] may specify the square of the sampling distance for idx. The value of sampling_distance_squared[ ] shall be in the range of 0 to xx.

adaptive_prediction_threshold may specify the threshold of prediction.

raht_depth may specify the number of levels of detail for RAHT. The value of depthRAHT may be in the range of 1 to xx.

raht_binarylevel_threshold may specify the levels of detail to cut out the RAHT coefficient. The value of binaryLevelThresholdRAHT shall be in the range of 0 to xx.

raht_quant_step_size may specify the quantization step size for the first component of the attribute. The value of quant_step_size shall be in the range of 1 to xx.

aps_extension_present_flag equal to 1 specifies that the aps_extension_data syntax structure is present in the APS RBSP syntax structure. aps_extension_present_flag equal to 0 specifies that this syntax structure is not present. When not present, the value of aps_extension_present_flag may be inferred to be equal to 0.

aps_extension_data_flag may have any value. Its presence and value do not affect decoder conformance to profiles specified in Annex A. Decoders conforming to a profile specified in Annex A.

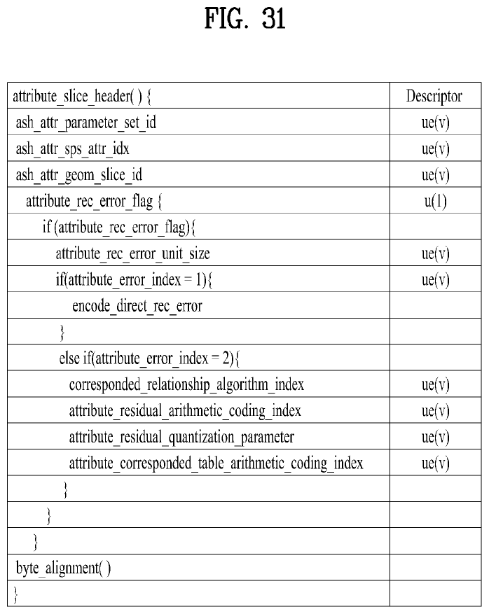

FIG. 31 shows an attribute slice header of Attr of a bitstream transmitted by a point cloud data transmission device (or a bitstream received by a point cloud data reception device) according to embodiments.

According to embodiments, corresponded_relationship_algorithm_index, attribute_residual_arithmetic_coding_index, attribute_residual_quantization_parameter, and attribute_corresponded_table_arithmetic_coding_index may represent the parameters described with reference to FIG. 28.

abh_attr_parameter_set_id specifies the value of the aps_attr_parameter_set_id of the active APS.

abh_attr_sps_attr_idx specifies the attribute set in the active SPS. The value of abh_attr_sps_attr_idx shall be in the range of 0 to sps_num_attribute_sets in the active SPS.

abh_attr_geom_slice_id specifies the value of geom slice id.

A method of transmitting point cloud data according to embodiments may include encoding point cloud data and/or transmitting a bitstream containing the point cloud data and signaling information.

The signaling information according to the embodiments may include information indicating whether to perform an error compression operation by reconstructing the transformed attribute information. A correspondence relationship according to embodiments may be determined by at least one of direct coding, a method of constructing an error table using a nearest-neighbor search algorithm, and a method of constructing an error table using a minimum error point search algorithm using the MSE. The signaling information according to the embodiments may further include information related to whether the method of determining a correspondence relationship is carried out. The signaling information according to the embodiments may further include information related to the operation of compressing the attribute reconstruction error. That is, in embodiments, the error table may include a difference between an attribute value of an input attribute and predicted attribute information (e.g., a mean square error distance between the two attributes).

According to embodiments, with the encoding method, the decoding method, and the signaling method using the weight-based Morton code generation method, the axis-based adaptive Morton code may support, from the perspective of the encoder and the decoder, increase of the compression rate and the image quality performance through the search of near neighbor nodes. The compression rate may be increased by change of the calculation method as many techniques for increasing the compression rate are added.

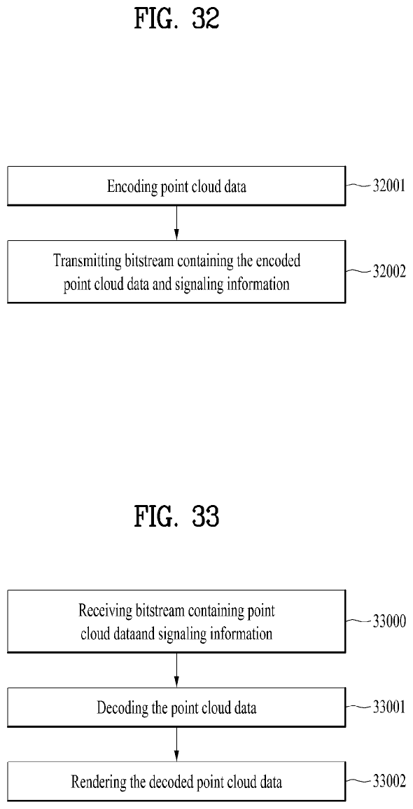

FIG. 32 is a flowchart illustrating a method of transmitting point cloud data according to embodiments.

A method of transmitting point cloud data (or an operation of a transmission device) according to embodiments may include encoding point cloud data (32001) and/or transmitting a bitstream containing the encoded point cloud data and signaling information (32002).

Regarding operation 32001, the encoding of the point cloud data may include encoding geometry information about the point cloud data and/or encoding attribute information about the point cloud data. According to embodiments, in operation 36001, the operation of the point cloud encoder 10002 described with reference to FIG. 1, the encoding 20001 described with reference to FIG. 2, the operations described with reference to FIGS. 4 to 9, all or some of the operations described with reference to FIG. 12, the point cloud encoding operations described with reference to FIGS. 14 and 15, and some or all of the operations described with reference to FIGS. 18 to 23 may be performed.

Operation 32001 may include encoding geometry information based on position information about points of the point cloud data, encoding attribute information about the points of the point cloud data based on reconstructed geometry information, and error-compressing the encoded attribute information. The reconstructed geometry information may be generated in the encoding of the geometry information.

In operation 32001, the error-compressing may include: reconstructing the encoded attribute information; determining whether to compress an attribute reconstruction error based on the reconstructed attribute information; when the attribute reconstruction error is compressed, determining a correspondence relationship between the reconstructed attribute information and the attribute information about the points of the point cloud data and generating the attribute reconstruction error; and compressing the attribute reconstruction error. Here, the attribute reconstruction error may indicate a residual between the reconstructed attribute information and the attribute information about the points of the point cloud data.

In addition, according to embodiments, in operation 32001, the method of transmitting point cloud data may further include determining a performance unit of the attribute information for performing the compressing of the attribute reconstruction error, and compressing the attribute reconstruction error. The compressing of the attribute reconstruction error may be compressing the attribute reconstruction error of the attribute information included in the performance unit of the attribute information. According to embodiments, the performance unit of the attribute information may be one or more 3D blocks including one or more pieces of the attribute information. Also, according to embodiments, the signaling information may include information on the performance unit of the attribute information.

Also, according to embodiments, the signaling information may include information indicating whether to perform the error-compressing by reconstructing transformed attribute information.

Also, according to embodiments, the correspondence relationship may be determined by at least one of direct coding, a method of constructing an error table using a nearest-neighbor search algorithm, and a method of constructing an error table using a minimum error point search algorithm based on MSE. The signaling information may further include information related to whether a method of determining the correspondence relationship is carried out. Here, the signaling information according to the embodiments may further include information related to compressing the residual information. In embodiments, the error table may include a difference between an attribute value of an input attribute and predicted attribute information (e.g., a Mean Square Error distance between the two attributes).

Regarding operation 32002, the point cloud data transmission device according to the embodiments may transmit a bitstream containing the encoded point cloud data. The operation according to operation 32002 may be performed by the transmitter of the PCC transmission device according to the embodiments described with reference to FIG. 1. The operation according to operation 32002 may correspond to the transmission 20002 of the PCC transmission method described with reference to FIG. 2. In operation 32002, for example, some or all of the operations according to the transmitter 10003 described with reference to FIG. 1, the transmission 20002 described with reference to FIG. 2, the transmission processor 12012 described with reference to FIG. 12, and/or the delivery described with reference to FIGS. 14 and 15 may be performed. According to embodiments, in operation 32002, for example, a bitstream according to the bitstream structure described with reference to FIG. 30 may be transmitted. According to embodiments, for example, in operation 32002, the bitstream as described with reference to FIGS. 27 to 31 may be transmitted.

FIG. 33 is a flowchart illustrating a method of receiving point cloud data according to embodiments.

A method of receiving point cloud data (or operation of a reception device) according to embodiments may include receiving point cloud data and signaling information (33000), decoding the received point cloud data (33001), and/or rendering the decoded point cloud data (33002).

Regarding operation 33000, the point cloud data reception device according to embodiments may receive the point cloud data and signaling information. According to embodiments, the signaling information may include prediction method information. Also, according to embodiments, all or part of the point cloud data and signaling information may be received by the syntax described with reference to FIGS. 27 to 31. The operation corresponding to operation 53700 may be performed by the receiver 10007 of the PCC reception device of FIG. 1.

Regarding operation 33001, the point cloud data reception device according to the embodiments may decode the received point cloud data. According to embodiments, the point cloud data reception device may include the point cloud decoder or the attribute information encoder described with reference to FIGS. 27 to 29. The operation corresponding to operation 33001 may be performed by the point cloud video decoder 10006 of the PCC reception device of FIG. 1. The operation corresponding to operation 33001 may be performed in the decoding 20003 of the PCC reception method of FIG. 2.

According to embodiments, in operation 33001, the decoding of the point cloud data may include: reconstructing geometry information from a geometry bitstream of the bitstream; decoding an attribute bitstream of the bitstream; based on the reconstructed geometry information, inversely transforming attribute information about points, and reconstructing the inversely transformed attribute information about the points based on residual information. Here, the decoding may generate attribute information and residual information about the points of the point cloud data.

According to embodiments, in operation 33001, the signaling information may include first information indicating whether to reconstruct the attribute information. In the reconstructing of the inversely transformed attribute information about the points, the reconstructed attribute information may be generated by adding or subtracting residual information to or from the inversely transformed attribute information about the points according to the first information.

According to embodiments, the signaling information may include information indicating whether to compress an attribute reconstruction error.

According to embodiments, a correspondence relationship may be determined by at least one of direct coding, a method of constructing an error table using a nearest-neighbor search algorithm, and a method of constructing an error table using a least error point search algorithm based on MSE. According to embodiments, the signaling information may further include information related to whether a method of determining the correspondence relationship is carried out. According to embodiments, the signaling information may further include information related to compressing the residual information. For example, in embodiments, the error table may include a difference between an attribute value of an input attribute and predicted attribute information (e.g., a Mean Square Error distance between the two attributes).

In relation to operation 33002, the point cloud data reception device according to the embodiments may render the decoded point cloud data. The operation according to operation 33002 may be performed by the renderer 10005 of the PCC reception device of FIG. 1.

Although the accompanying drawings have been described separately for simplicity, it is possible to design new embodiments by merging the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Descriptions of methods and devices of the invention may be applied so as to complement each other. For example, the point cloud data transmission method described in the present disclosure may be carried out by the point cloud data transmission device or components included in the point cloud data transmission device according to the embodiments. Also, the point cloud data reception method described in the present disclosure may be carried out by the point cloud data reception device or components included in the point cloud data reception device according to the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this specification, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

### MODE FOR DISCLOSURE

As described above, related contents have been described in the best mode for carrying out the embodiments.

### INDUSTRIAL APPLICABILITY

It will be apparent to those skilled in the art that various changes or modifications can be made to the embodiments within the scope of the embodiments. Thus, it is intended that the embodiments cover the modifications and variations of this disclosure provided they come within the scope of the appended claims and their equivalents.

1. A method for transmitting point cloud data, the method comprising:
encoding point cloud data; and
transmitting a bitstream including the point cloud data and signaling information.

2. The method of claim 1, wherein the encoding of the point cloud data comprises:
encoding geometry information based on position information for points of the point cloud data;
reconstructing the geometry information;
encoding attribute information for the points of the point cloud data based on the reconstructed geometry information; and
error-compressing the encoded attribute information.

3. The method of claim 2, wherein the error-compressing comprises:
reconstructing the encoded attribute information;
determining whether to compress an attribute reconstruction error based on the reconstructed attribute information, wherein the attribute reconstruction error indicating a residual between the reconstructed attribute information and the attribute information for the points of the point cloud data;
generating the attribute reconstruction error based on a correspondence relationship between the reconstructed attribute information and the attribute information for the points of the point cloud data when the attribute reconstruction error is compressed; and
compressing the attribute reconstruction error.

4. The method of claim 3, further comprising:
determining a performance unit of the attribute information for performing the compressing of the attribute reconstruction error,
wherein the compressing of the attribute reconstruction error is compressing the attribute reconstruction error of the attribute information included in the performance unit of the attribute information,
wherein the performance unit of the attribute information is a tile, and
wherein the signaling information includes information for the performance unit of the attribute information.

5. The method of claim 2, wherein the signaling information includes information indicating whether to perform the error-compressing by reconstructing the attribute information.

6. The method of claim 3, wherein the correspondence relationship is determined by at least one of direct coding, a method of constructing an error table using a nearest-neighbor search algorithm, and a method of constructing an error table using a least error point search algorithm based on a mean square error (MSE),
wherein the signaling information further includes information related to whether a method of determining the correspondence relationship is performed,
wherein the signaling information further includes information related to the compressing the attribute reconstruction error.

7. An apparatus for transmitting point cloud data, comprising:
an encoder configured to encode the point cloud data; and
a transmitter configured to transmit a bitstream including the point cloud data and signaling information.

8. The apparatus of claim 7, wherein the encoder comprises:
a geometry encoder configured to encode geometry information based on position information for points of the point cloud data;
a geometry reconstructor configured to reconstruct the geometry information;
an attribute encoder configured to encode attribute information for the points of the point cloud data based on the reconstructed geometry information; and
an error compressor configured to error-compress the encoded attribute information.

9. The apparatus of claim 8, wherein the error compressor comprises:
an attribute reconstructor configured to reconstruct the encoded attribute information;
an error compression checker configured to determine whether to compress an attribute reconstruction error based on the reconstructed attribute information, wherein the attribute reconstruction error indicating a residual between the reconstructed attribute information and the attribute information for the points of the point cloud data;
an attribute reconstruction error generator configured to generate the attribute reconstruction error based on a correspondence relationship between the reconstructed attribute information and the attribute information for the points of the point cloud data when compressing of the attribute reconstruction error is determined; and
a residual compressor configured to compress the attribute reconstruction error.

10. The apparatus of claim 9,
the apparatus determines a performance unit of the attribute information for performing the compressing of the attribute reconstruction error,
wherein the attribute reconstruction error compressor compresses attribute reconstruction error of attribute information included in the performance unit of the attribute information,
wherein the performance unit of the attribute information is a tile,
wherein the signaling information includes information for the performance unit of the attribute information.

11. The apparatus of claim 8, wherein the signaling information includes information indicating whether to perform the error-compressing by reconstructing the attribute information.

12. The apparatus of claim 9, wherein the correspondence relationship is determined by at least one of direct coding, a method of constructing an error table using a nearest-neighbor search algorithm, and a method of constructing an error table using a least error point search algorithm based on a mean square error (MSE),
wherein the signaling information further includes information related to whether a method of determining the correspondence relationship is performed,
wherein the signaling information further includes information related to compressing the attribute reconstruction error.

13. A method of receiving point cloud data, the method comprising:
receiving a bitstream including the point cloud data and signaling information;
decoding the point cloud data; and
rendering the point cloud data.

14. The method of claim 13, wherein the decoding of the point cloud data comprises:
reconstructing geometry information from a geometry bitstream of the bitstream;
decoding an attribute bitstream of the bitstream, wherein the decoding generates attribute information and residual information for points of the point cloud data;
inversely transforming the attribute information for the points based on the reconstructed geometry information; and
reconstructing the inversely transformed attribute information for the points based on the residual information.

15. The method of claim 14, wherein the signaling information includes first information indicating whether to reconstruct the attribute information,
wherein the reconstructing of the inversely transformed attribute information for the points performs generating the reconstructed attribute information by adding or subtracting the residual information to or from the inversely transformed attribute information for the points in response to the first information.

16. The method of claim 15, wherein the signaling information further includes second information related to a correspondence relationship between the residual information and the inversely transformed attribute information for the points and third information related to a compression method for the residual information,
wherein the reconstructing of the inversely transformed attribute information for the points performs adding or subtracting the residual information to or from the inversely transformed attribute information for the points based on the second information,
wherein the reconstructing of the inversely transformed attribute information for the points performs reconstructing by decoding the added or subtracted attribute information based on the third information.

17. An apparatus for receiving point cloud data, comprising:
a receiver configured to receive a bitstream including the point cloud data and signaling information;
a decoder configured to decode the point cloud data; and
a renderer configured to render the point cloud data.

18. The apparatus of claim 17, wherein the decoder to decode the point cloud data comprises:
a geometry reconstructor configured to reconstruct geometry information from a geometry bitstream of the bitstream;
an attribute decoder configured to decode an attribute bitstream of the bitstream, wherein the attribute decoder generates attribute information and residual information for points of the point cloud data;
an inverse transform processor configured to inversely transform the attribute information for the points based on the reconstructed geometry information; and
an attribute reconstructor configured to reconstruct the inversely transformed attribute information for the points based on the residual information.

19. The apparatus of claim 18, wherein the signaling information includes first information indicating whether to reconstruct the attribute information,
wherein the attribute reconstructor generates the reconstructed attribute information by adding or subtracting the residual information to or from the inversely transformed attribute information for the points in response to the first information.

20. The apparatus of claim 19, wherein the signaling information further includes second information related to a correspondence relationship between the residual information and the inversely transformed attribute information for the points and third information related to a compression method for the residual information,
wherein the attribute reconstructor performs adding or subtracting the residual information to or from the inversely transformed attribute information for the points based on the second information; and
wherein the attribute reconstructor performs reconstructing by decoding the added or subtracted attribute information based on the third information.
